(19) United States
(12) Patent Application Publication
(10) Pub. No.: US 2009/0059416 A1
(43) Pub. Date: Mar. 5, 2009

(54) STORAGE DEVICE, STORAGE MEDIUM, AND METHOD FOR MANUFACTURING STORAGE MEDIUM

(75) Inventors: Makoto Okada, Higashine (JP); Eishin Yamakawa, Higashine (JP); Yoshihiro Mitobe, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/172,730

(22) Filed: Jul. 14, 2008

(30) Foreign Application Priority Data
Aug. 27, 2007 (JP) 2007-220207

(51) Int. Cl. G11B 21/02; G11B 5/33

(52) U.S. Cl. 360/75; 360/313

(57) ABSTRACT

According to an aspect of an embodiment, an storage device includes a storage medium having a substrate, a storage medium layer for storing information, a first lubricating layer on a first area of the storage medium layer, and a second lubricating layer on a second area of the storage medium, the second lubricating layer having a viscosity lower than the first lubricating layer. The storage device further comprises a head for writing information into the storage medium layer or reading information from the storage medium layer.

### BACKGROUND

This art relates to a storage medium, a method for manufacturing the storage medium, and a storage device including the storage medium.

With the widespread use of computers, a great amount of information is being handled on a daily basis. As one of devices that record and reproduce such a great amount of information, storage devices, typified by hard disk drives (HDDs), have been used. HDDs include a magnetic disk (magnetic storage medium) as a storage medium and a magnetic head. Information is recorded on or reproduced from the magnetic disk by the magnetic head.

A magnetic disk includes a nonmagnetic substrate and a magnetic layer formed on the substrate. The magnetic layer is formed of a ferromagnetic material. A magnetic layer includes a plurality of minute domains. Information is stored as magnetization directions in these minute domains. The magnetic layer is covered with a protective layer, for example, formed of carbon. The protective layer is covered with a lubricating layer, for example, formed of perfluoropolyether (PFPE).

Year by year, there is an increasing demand for magnetic storage media, typified by magnetic disks, having a higher recording density. One of means to increase the magnetic recording density is to reduce the flying height of a magnetic head. To this end, the flying height of a magnetic head must be controlled precisely.

In some cases, to maintain the flying height constant, information about the position of a magnetic head in contact with a magnetic disk is acquired (hereinafter referred to as “zero height detection”) before the operation of a magnetic storage device. On the basis of the position information (zero height), the magnetic storage device controls the distance between the magnetic head and the magnetic disk to achieve a predetermined flying height. In particular, the zero height detection is preferably performed in a magnetic storage device including a floating-head of a so-called dynamic flying height (DFH) type, in which the flying height is adjusted to changes in the environment inside the magnetic storage device, such as dimensional changes of components constituting the magnetic storage device or changes in the density of air molecules.

In a magnetic storage device including a magnetic head of a DFH type, the zero height detection is performed as follows: first, a read-write element is heated to protrude by thermal expansion; then, the magnetic head having the protruding element is brought into contact with a magnetic disk. The height information of the tip of the element is stored as a “zero” height in memory.

In the zero height detection, the contact between the tip of a magnetic head element and a lubricating layer of a magnetic storage medium causes vibrations of the magnetic head. A large amplitude of the vibrations may result in inaccurate detection of height information of the tip of the element.

In general, a lubricating layer reduces the wearing away of a magnetic disk due to the sliding of a magnetic head. The lubricating layer also protects information stored on a magnetic layer from contact between a magnetic head and a magnetic disk (head crash). For example, Japanese Laid-open Patent Publication No. 2004-199723 discloses a magnetic storage medium in which an inner area for recording and an outer area for loading a magnetic head are coated with different lubricants. However, in the magnetic storage medium disclosed in this patent document, the lubricants are selected to improve the impact resistance of the magnetic storage medium. Thus, zero height detection performed on a lubricant covering the inner area or the outer area may cause the magnetic head to vibrate with a large amplitude.

Japanese Laid-open Patent Publication No. 2006-147012 discloses a magnetic storage medium that includes a lubricating layer composed of two layers: a fixed layer (bond layer) disposed on a protective layer and a fluid layer (free layer) disposed on the fixed layer. The fixed layer is chemically stable and adheres moderately to the protective layer. The fluid layer is formed of a material having a low friction coefficient. However, in the magnetic storage medium disclosed in this patent document, zero height detection performed on the lubricating layer composed of the fixed layer and the fluid layer may cause a magnetic head to vibrate with a large amplitude.

In view of the situations described above, it is an object of the present invention to provide a storage device in which the contact between a head and a storage medium in zero height detection causes reduced vibrations of the head.

### SUMMARY

According to an aspect of an embodiment, an storage device includes: a storage medium having a substrate, a storage medium layer for storing information, a first lubricating layer on a first area of the storage medium layer, and a second lubricating layer on a second area of the storage medium, the second lubricating layer having a viscosity lower than the first lubricating layer; and a head for writing information into the storage medium layer or reading information from the storage medium layer.

### BRIEF DESCRIPTION OF THE DRAWINGS

FIG. 1 is a schematic view of a storage device (hard disk drive (HDD)) including a storage medium according to an embodiment;

FIGS. 2A and 2B are a schematic plan view and a schematic cross-sectional view of a storage medium according to an embodiment;

FIGS. 3A to 3D are schematic views illustrating the steps of zero height detection;

FIG. 4 is a process drawing of a method for manufacturing a storage medium according to an embodiment;

FIGS. 5A to 5D are schematic views illustrating the steps of the method for manufacturing a storage medium according to an embodiment shown in FIG. 4;

FIGS. 6A to 6D are schematic views illustrating the steps of the method for manufacturing a storage medium according to an embodiment shown in FIG. 4;

FIG. 7 is a schematic structure of a magnetic disk drive according to an embodiment;

FIG. 8 is a flowchart of a method for adjusting the flying height of a magnetic head;

FIGS. 9A to 9C are states of a head gimbal assembly 104 in main steps shown in the flowchart in FIG. 8;

FIGS. 10A and 10B are each a graph showing an example of a signal 11c supplied from a filter circuit 214;

FIG. 11A is a graph showing the relationship between the energy input to a heater 170 and the flying height of a magnetic head, and FIG. 11B is a graph showing the relationship between the energy input to the heater 170 and the signal strength;

FIGS. 12A and 12B each show an example of a structure in which a sensor 150 is disposed at position A;

FIGS. 13A and 13B each show an example of a structure in which the sensor 150 is disposed at position B;

FIGS. 14A and 14B each show an example of a structure in which the sensor 150 is disposed at position C;

FIG. 15 is an enlarged view of the head gimbal assembly 104;

FIGS. 16A and 16B each show a structure of the sensor 150;

FIG. 17 is a schematic view illustrating means to measure the displacement of vibrations;

FIG. 18 is a graph of the displacement of a magnetic head in zero height detection as a function of the viscosity of a second lubricating layer; and

FIGS. 19A to 19D are photographs of a magnetic head taken with a microscope (19A and 19B) and an optical surface analyzer (OSA) (19C and 19D).

### DESCRIPTION OF THE PREFERRED EMBODIMENTS

### 1. Storage Medium

A storage medium according to an embodiment includes a substrate, a storage medium layer for storing information, a first lubricating layer on a first area of the storage medium layer, and a second lubricating layer on a second area of the storage medium, the second lubricating layer having a viscosity lower than the first lubricating layer.

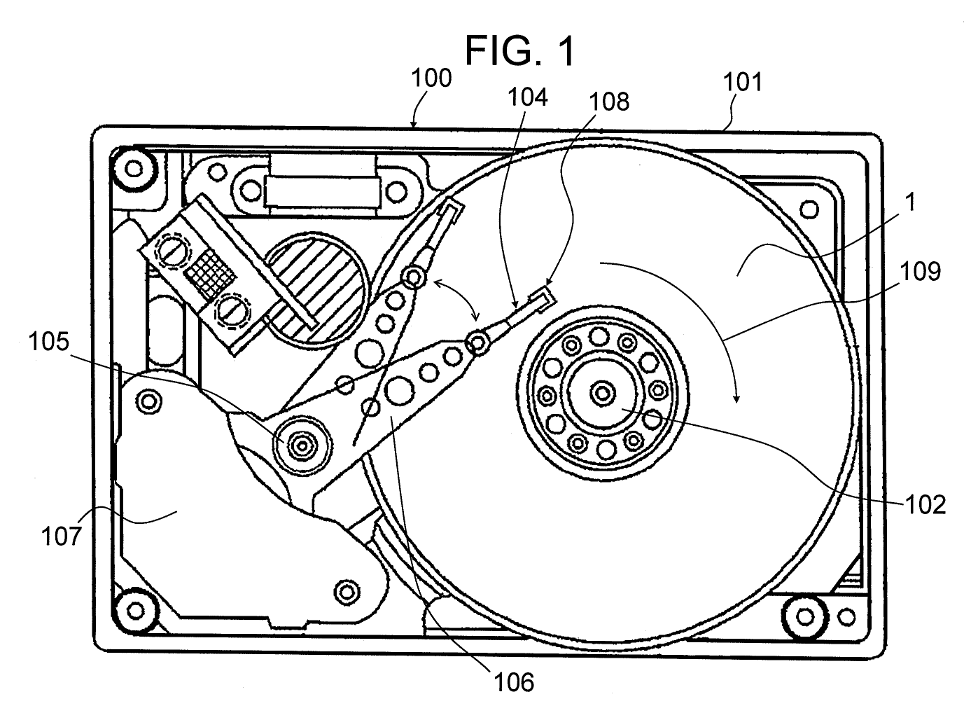

A magnetic storage device including a storage medium according to an embodiment will be described below with reference to FIG. 1. FIG. 1 is a schematic view of a magnetic storage device (hard disk drive (HDD)) including a storage medium according to an embodiment. A HDD 100 includes a housing 101, a storage medium (magnetic disk) 103 mounted on a spindle motor 102, and a head gimbal assembly 104, which faces the storage medium 103 and includes a magnetic head 108. The magnetic head 108 writes information on or reads information from the storage medium 103. The magnetic head 108 includes an element member (not shown) for writing information on or reading information from the storage medium 103 and a slider substrate (not shown), which includes the element member and faces the storage medium 103.

The head gimbal assembly 104 including the magnetic head 108 is fixed at the tip of a carriage arm 106, which can swing on a shaft 105 in and out along an arc over the storage medium 103. An actuator 107 drives the carriage arm 106 to allow the magnetic head 108 to seek a target recording track of the magnetic disk 103. Thus, the magnetic head 108 can write information on and read information from the storage medium 103.

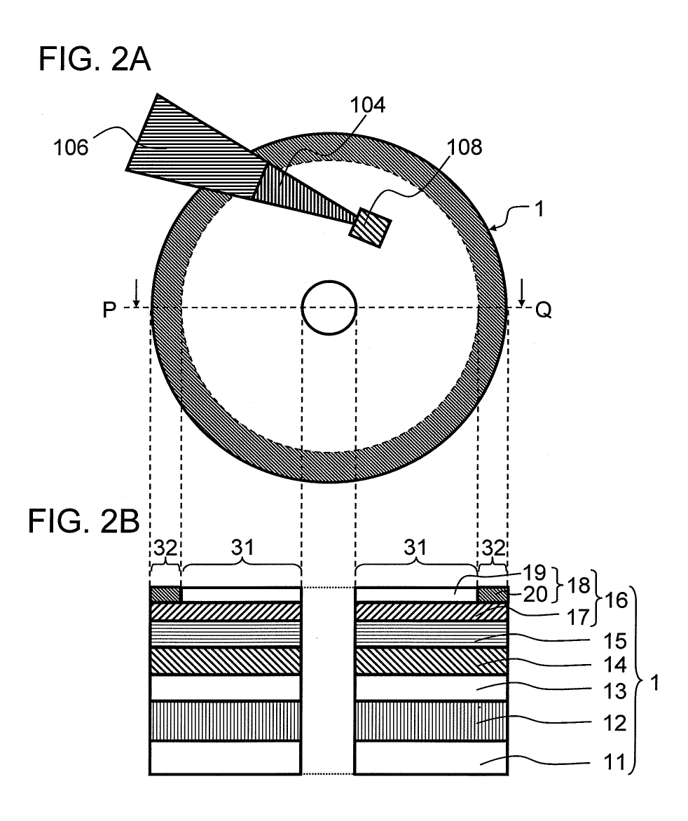

A storage medium according to an embodiment will be described below. FIGS. 2A and 2B are a schematic plan view and a schematic cross-sectional view, respectively, of a magnetic storage medium according to an embodiment. A magnetic storage medium 1 includes a soft under layer 12, an intermediate layer 13, a storage medium layer 14, and a protective layer 15, layered over a substrate 11. The protective layer 15 is coated with a lubricating layer 16. The magnetic storage medium 1 may have any desired shape and is, in general, discoid.

The shape, the structure, the size, and the material of the substrate 11 may be appropriately selected for each purpose. When a magnetic storage medium 1 according to the present embodiment is installed in a magnetic disk unit, the shape of the substrate 11 is discoid, and the substrate 11 may have a monolayer structure or a layered structure. The material of the substrate 11 may be appropriately selected from known substrate materials for magnetic recording media. Examples of the material include nonmagnetic materials, such as aluminum, NiP-plated aluminum, glass, silicon, quartz, and SiO₂/Si prepared by forming a thermally oxidized film on a silicon surface (the slash “/”, as used herein, means that materials or layers in front of and behind the slash are layered). These substrate materials may be used alone or in combination. The substrate 11 may be appropriately manufactured or may be a commercial product.

The soft under layer (SUL) 12 may have any shape, any structure, and any size and may be appropriately selected from known soft under layers for each purpose. The soft under layer 12 may be suitably formed of at least one material selected from the group consisting of Ru, Ru alloys, NiFe, FeSiAl, FeC, FeCoB, FeCoNiB, and CoZrNb. These materials may be used alone or in combination.

The intermediate layer 13 is provided to improve the orientation of a storage medium layer 14 mainly in perpendicular magnetic recording media. The intermediate layer 13 may have any shape, any structure, and any size and may be appropriately selected from known intermediate layers for each purpose. The intermediate layer 13 may be suitably formed of a material selected from the group consisting of Ni alloys, Ru, Ru alloys, and CoCr alloys containing an oxide.

The storage medium layer 14 is a magnetic layer for recording and reproducing information. The material of the storage medium layer 14 may be appropriately selected from known materials for each purpose. For example, the storage medium layer 14 is suitably formed of at least one material selected from the group consisting of Fe, Co, Ni, FeCo, FeNi, CoNi, CoNiP, FePt, CoPt, and NiPt. These materials may be used alone or in combination. The shape and the structure of the storage medium layer 14 may be appropriately selected for each purpose, provided that the storage medium layer 14 is formed, as a magnetic thin film, of the material described above. The thickness of the storage medium layer 14 may be appropriately selected in a manner that depends on the linear recording density, provided that the advantages of the present invention are not reduced.

The protective layer 15 protects the storage medium layer 14 from a physical impact caused by accidental contact between the magnetic head 108 and the magnetic storage medium 1 during the operation of the magnetic storage device, thus preventing the deterioration of recording and reproducing performance. Preferably, the material of the protective layer 15 is, but not limited to, diamond-like carbon (DLC).

The soft under layer 12, the intermediate layer 13, the storage medium layer 14, and the protective layer 15 may be formed by any known method. For example, these layers may be formed by sputtering, electrodeposition, or (alternating current) plating.

Preferably, the protective layer 15 has a polar group on the surface thereof. This is because, when a fixed layer 17 of the lubricating layer 16 contains a lubricant having a polar group, the intermolecular interaction between the protective layer 15 and the fixed layer 17 via the polar groups improves the adhesion therebetween and thereby the adhesion between the protective layer 15 and the lubricating layer 16. The polar group of the protective layer 15 may be any polar group and is a nitrile group, for example. A DLC layer having a nitrile group on the surface thereof may be formed by plasma chemical vapor deposition (CVD). Alternatively, a DLC layer may be formed by sputtering and then may be subjected to nitrogen etching to produce a nitrile group on the surface thereof. A protective layer having a polar group on the surface thereof according to the present embodiment corresponds to a layer having a second polar group according to the present invention.

The lubricating layer 16 includes the fixed layer 17 disposed on the protective layer 15 and a fluid layer 18 disposed on the fixed layer 17. The fluid layer 18 includes an inner first lubricating layer 19 and an outer second lubricating layer 20. The first lubricating layer 19 and the second lubricating layer 20 are exposed at the surface of the magnetic storage medium 1. The lubricating layer 16, in combination with the protective layer 15, protects the storage medium layer 14 from a physical impact. The lubricating layer 16 also prevents the corrosion of the soft under layer 12, the intermediate layer 13, and the storage medium layer 14.

The fixed layer 17 is disposed between the protective layer 15 and the fluid layer 18 and improves the adhesion therebetween. The lubricant contained in the fixed layer 17 may be of any type. In terms of adhesiveness, preferably, the fixed layer 17 and the first lubricating layer 19 contain the same lubricant or a lubricant having a similar main skeleton (for example, a skeletal structure denoted by X in structural formula (1) described below). More preferably, the lubricant of the fixed layer 17 contains the same material as the first lubricating layer 19. The fixed layer 17 may be formed by any method. For example, after a lubricant having a polar group for use in the first lubricating layer 19 is applied to the protective layer 15 having a polar group on the surface thereof, the lubricant is baked to form the fixed layer 17 on the protective layer 15 and the first lubricating layer 19 on the fixed layer 17. The fixed layer 17 is fixed on the protective layer 15 by the intermolecular interaction between the polar group of the fixed layer 17 and the polar group on the surface of the protective layer 15. The fixed layer 17 thus formed improves the adhesion between the fixed layer 17 and the protective layer 15 and between the fixed layer 17 and the fluid layer 18. This reduces the wearing away of the lubricating layer 16 due to the rotation of the magnetic storage medium 1 for a long period of time, thus imparting durability to the magnetic storage medium 1. The polar group of the fixed layer 17 may be, but not limited to, a hydroxyl group. The fixed layer 17 and the first lubricating layer 19 may be formed without baking. However, baking increases the thickness of the fixed layer 17 and improves the adhesiveness. The thickness of the fixed layer 17 may be, but not limited to, in the range of 1 to 10 angstroms and preferably in the range of 5 to 10 angstroms.

The polar group of the fixed layer 17 corresponds to a first polar group according to the present invention. The lubricant contained in the fixed layer 17 may be formed of a material different from that of the first lubricating layer 19.

The first lubricating layer 19 is disposed in an area (recording area) 31 located closer to the element member of the magnetic head 108 than the second lubricating layer 20 is, when information is recorded on or reproduced from the storage medium layer 14. The first lubricating layer 19, in combination with the protective layer 15, protects the storage medium layer 14 from a physical impact. The first lubricating layer 19 also prevents the corrosion of the soft under layer 12, the intermediate layer 13, and the storage medium layer 14.

The first lubricating layer 19 may have any viscosity, provided that the first lubricating layer 19 has a viscosity higher than that of the second lubricating layer 20. Preferably, to prevent the adhesion of the lubricant contained in the first lubricating layer 19 to the magnetic head 108, the viscosity of the first lubricating layer 19 is at least 4 Pa·s at 20° C.

The first lubricating layer 19 may contain one lubricant or two or more lubricants. The material of the first lubricating layer 19 may be, but not limited to, a fluorinated material, such as a perfluoropolyether (PFPE), and preferably perfluoropolyether having the structural formula (1).

R1-X-R2 (1)

X: —CF₂—O—(CF₂—CF₂—O)ₚ—(CF₂O)_{q}—CF₂—

(wherein p and q denote a natural number in the range of 1000 to 5000)

R1 and R2: a group selected from an end group A, an end group B, an fluorine atom, or a hydrogen atom, wherein the end group A and the end group B have the following formula.

End group A: —CH₂OCH₂CH(OH)CH₂OH

End group B: —CH₂OH

Preferably, the content of a perfluoropolyether lubricant having end groups A at both sides of X and no end group B is at least 90% by weight to achieve the viscosity of the first lubricating layer 19 of at least 4 Pa·s. Such a lubricant may be a commercially available material, for example, Fomblin Z-Tetraol (manufactured by Solvay Solexis). The thickness of the first lubricating layer 19 may be, but not limited to, a few angstroms and preferably in the range of one to two angstroms.

In the present embodiment, preferably, the protective layer 15 has a polar group on the surface thereof, and the first lubricating layer 19 contains a lubricant having a polar group. When the lubricant contained in the first lubricating layer 19 has a polar group, a lubricant contained in the fixed layer 17 also has a polar group. The fixed layer 17 is fixed on the protective layer 15 by the intermolecular interaction between the polar group of the fixed layer 17 and the polar group on the surface of the protective layer 15. Since the fixed layer 17 and the first lubricating layer 19 contain the same lubricant or a lubricant having a similar main skeleton (for example, a skeletal structure denoted by X in the structural formula (1)), the adhesion between the fixed layer 17 and the first lubricating layer 19 is strong. Thus, the lubricating layer 16 is resistant to detachment from the magnetic storage medium 1.

The second lubricating layer 20 receives the magnetic head 108 and thereby determines the distance between the magnetic head 108 and the magnetic storage medium 1. Thus, the second lubricating layer 20 is formed in an area 32 designed for zero height detection in the magnetic storage medium 1. As shown in FIG. 2B, the second lubricating layer 20 is disposed outside the first lubricating layer 19. A first advantage of this structure is that a magnetic storage medium can be easily and inexpensively manufactured by a method for manufacturing a magnetic storage medium described below. A second advantage is that a centrifugal force caused by the rotation of the magnetic storage medium 1 prevents the transferable second lubricating layer 20 from being transferred to the first lubricating layer 19 or even the magnetic head 108, thus reducing the deterioration of recording and reproducing performance. In a storage medium according to the present embodiment, the position of the second lubricating layer 20 is not limited to an outer area and may be an inner area or an intermediate area. Furthermore, the second lubricating layer 20 is not limited to circumferential and may be arcuate.

The term “zero height detection”, as used herein, means that information about the height of a magnetic head in contact with a magnetic storage medium is acquired. The zero height detection is generally performed before the operation of a magnetic storage device to maintain the flying height of a magnetic head constant in the magnetic storage device. On the basis of the height information (zero height), the position of an element member of the magnetic head is controlled to ensure a predetermined flying height. The control of the flying height can reduce uneven flying heights between magnetic storage devices. In particular, the zero height detection is preferably performed in a magnetic storage device including a floating-head of a so-called dynamic flying height (DFH) type, in which the flying height is adjusted to changes in the environment inside the magnetic storage device, such as dimensional changes of components constituting the magnetic storage device or changes in the density of air molecules.

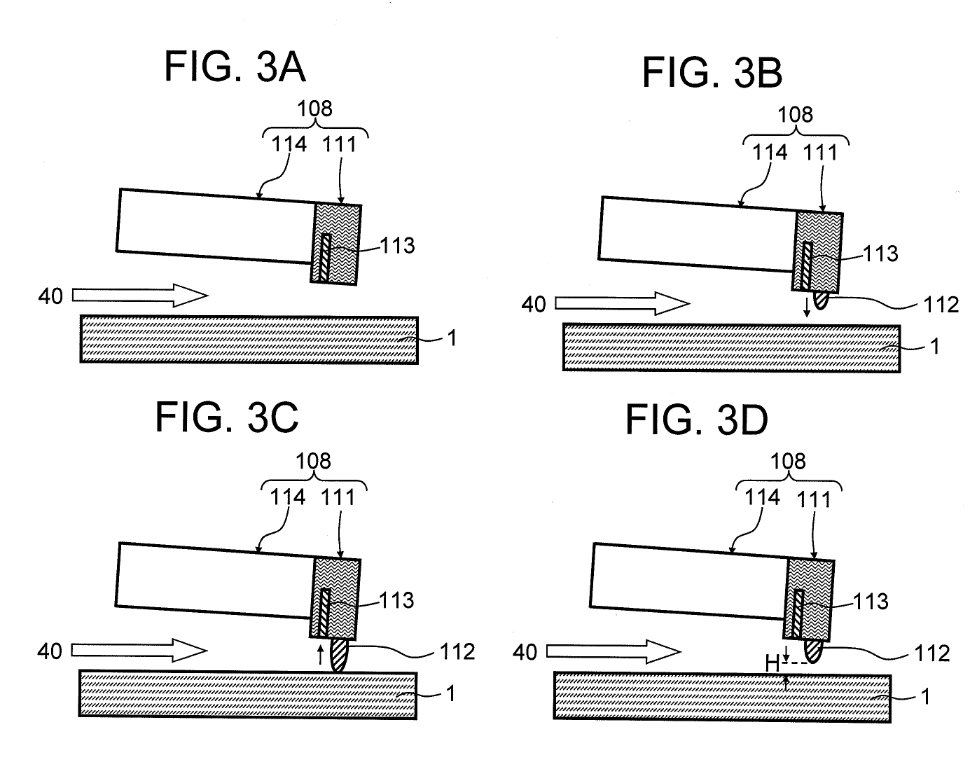

In a magnetic storage device including a magnetic head of a DFH type, the zero height detection is performed as described below. FIGS. 3A to 3D are schematic views illustrating the steps of the zero height detection.

As illustrated in FIG. 3A, a magnetic disk 103 is firstly rotated to produce an air current 40, thereby allowing the magnetic head 108 to plane over the magnetic disk 103. As illustrated in FIG. 3B, a read-write element 111 is heated by a heater 113 to protrude toward the magnetic disk 103, thus forming a protrusion 112. As illustrated in FIG. 3C, the protrusion 112 is brought into contact with the magnetic disk 103. The height information of the tip of the protrusion 112 in contact with the magnetic disk 103 is stored as a “zero” height in memory (not shown), such as random access memory (RAM). As illustrated in FIG. 3D, on the basis of the zero height stored in memory, the length of the protrusion 112 is controlled to achieve a predetermined flying height H. Thus, information can be recorded and reproduced stably.

In a magnetic storage device including the magnetic storage medium 1 according to the present embodiment, the zero height detection is performed such that the protrusion of the magnetic head 108 comes into contact with the second lubricating layer 20. Since the second lubricating layer 20 has a viscosity lower than that of the first lubricating layer 19, which protects an area for recording and reproducing information, the repulsive force (impact) of the second lubricating layer 20 on the protrusion of the magnetic head 108 in zero height detection is reduced. This reduces the amplitude of vibrations of the magnetic head 108 coming into contact with the second lubricating layer 20. Accordingly, the precision of zero height detection is improved, and the flying height can be precisely controlled during the operation of a magnetic storage device. Thus, the magnetic storage device according to the present embodiment can stably record information on and reproduce information from the magnetic storage medium 1.

The second lubricating layer 20 may have any viscosity, provided that the second lubricating layer 20 have a viscosity lower than that of the first lubricating layer 19. Preferably, to reduce the amplitude of vibrations of the magnetic head 108 caused by zero height detection, the viscosity of the second lubricating layer 20 is 1 Pa·s or less at 20° C.

The second lubricating layer 20 may contain one lubricant or two or more lubricants. The material of the second lubricating layer 20 may be, but not limited to, a fluorinated material, such as a perfluoropolyether (PFPE), and preferably perfluoropolyether having the structural formula (2).

R3-Y-R4 (2)

Y: —CF₂—O—(CF₂—CF₂—O)ₚ—(CF₂O)_{q}—CF₂—

(wherein p and q denote a natural number in the range of 1000 to 5000)

R3 and R4: a group selected from an end group A, an end group B, an fluorine atom, or a hydrogen atom, wherein the end group A and the end group B have the following formula.

End group A: —CH₂OCH₂CH(OH)CH₂OH

End group B: —CH₂OH

Preferably, the content of a perfluoropolyether lubricant having end groups B at both sides of Y and no end group A is at least 80% by weight to achieve the viscosity of the second lubricating layer 20 of 1 Pa·s or less. Such a lubricant may be a commercially available material, for example, Fomblin Z-Dol (manufactured by Solvay Solexis). The thickness of the second lubricating layer 20 may be, but not limited to, a few angstroms and preferably in the range of one to two angstroms. Preferably, the surface of the second lubricating layer 20 is substantially flush with the surface of the first lubricating layer 19.

In the magnetic storage medium 1 illustrated in FIG. 2B, the second lubricating layer 20 is disposed on the fixed layer 17. Since the main skeleton X (see structural formula (1)) of the lubricant contained in the fixed layer 17 and the main skeleton Y (see structural formula (2)) of the lubricant contained in the second lubricating layer 20 are identical or similar to each other, the adhesion between the fixed layer 17 and the second lubricating layer 20 is strong.

In the magnetic storage medium 1 according to the present embodiment, the second lubricating layer 20 may be formed directly on the protective layer 15 instead of the fixed layer 17. When the second lubricating layer 20 is formed on the protective layer 15, R3 and R4 in structural formula (2) may not have a polar group, such as a hydroxyl group.

In the formation of the fixed layer 17 and the first lubricating layer 19, a solution for forming the first lubricating layer 19 is applied to the protective layer 15 and is then aftertreated to form the fixed layer 17.

The solution for forming the first lubricating layer 19 may be applied by any means, including dipping. In the dipping method, a lubricant solution is applied to the protective layer 15 by dipping a medium plate member of from the substrate 11 to the protective layer 15 in the lubricant solution and then pulling up the medium plate member or lowering the lubricant solution level. The dipping method is suitable for mass production and can control the film thickness easily. The dipping method can also achieve a uniform thickness. In place of dipping, spin coating or spray coating may be used.

After the application of the solution for forming the first lubricating layer 19, aftertreatment is performed to form the fixed layer 17. The fixed layer 17 can improve the adhesion between the protective layer 15 and the lubricating layer 16. In general, the aftertreatment is heat treatment (baking).

The second lubricating layer 20 may be formed by any means. When the second lubricating layer 20 is formed in an outer area of the magnetic storage medium 1, dipping is preferred in terms of productivity. Means to form the second lubricating layer 20 will be described below in the section of a method for manufacturing a magnetic storage medium.

According to the magnetic storage medium 1 of the present embodiment, the lubricating layer 16, which has a viscosity lower than known lubricating layers, can absorb an impact of the magnetic head 108 on the lubricating layer 16 during zero height detection. This reduces the amplitude of vibrations of the magnetic head 108 caused by the impact and accordingly improves the precision of zero height detection. Consequently, the flying height is controlled precisely, and information can be stably recorded on and reproduced from the storage medium.

While the storage medium layer 14 is a magnetic storage medium layer in the present embodiment, the storage medium layer 14 may be a storage medium layer of another type, provided that information can be recorded and reproduced in a storage medium according to the present invention.

### 2. Method for Manufacturing Storage Medium

In a method for manufacturing a storage medium according to an embodiment, a method for manufacturing a magnetic storage medium includes: providing a substrate, and a storage medium layer on the substrate for storing information; arranging a first lubricating layer on the storage medium layer; removing an outer portion of the first lubricating layer; and arranging a second lubricating layer on a area of the storage medium layer from which the first lubricating layer is removed, the first lubricating layer being outer than the second lubricating layer, the second lubricating layer having lower viscosity than the first lubricating layer. The method for manufacturing a storage medium according to the embodiment has advantages that the storage medium can be manufactured easily and inexpensively and that, during the operation of a storage device including the storage medium, the deterioration of recording and reproducing performance is reduced by preventing the transferable second lubricating layer from being transferred to a magnetic head.

A method for manufacturing a storage medium according to an embodiment will be described below.

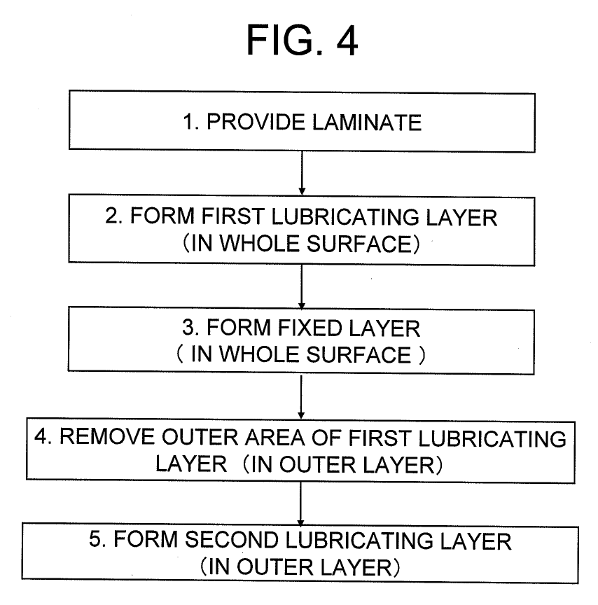

FIG. 4 is a process drawing of a method for manufacturing a magnetic storage medium, which is an embodiment of a method for manufacturing a storage medium.

A first step according to the present embodiment is the step of providing a medium plate member that includes a magnetic storage medium layer disposed on at least one side of a substrate and a protective layer for protecting the magnetic storage medium layer.

A second step according to the present embodiment is the step of forming a fluid first lubricating layer on the medium plate member provided in the first step.

A third step according to the present embodiment is the step of forming a fixed layer to bring the medium plate member into intimate contact with the first lubricating layer formed in the second step.

A fourth step according to the present embodiment is the step of removing at least part of an outer area of the first lubricating layer.

A fifth step according to the present embodiment is the step of forming a second lubricating layer in the at least part of an outer area from which the first lubricating layer is removed.

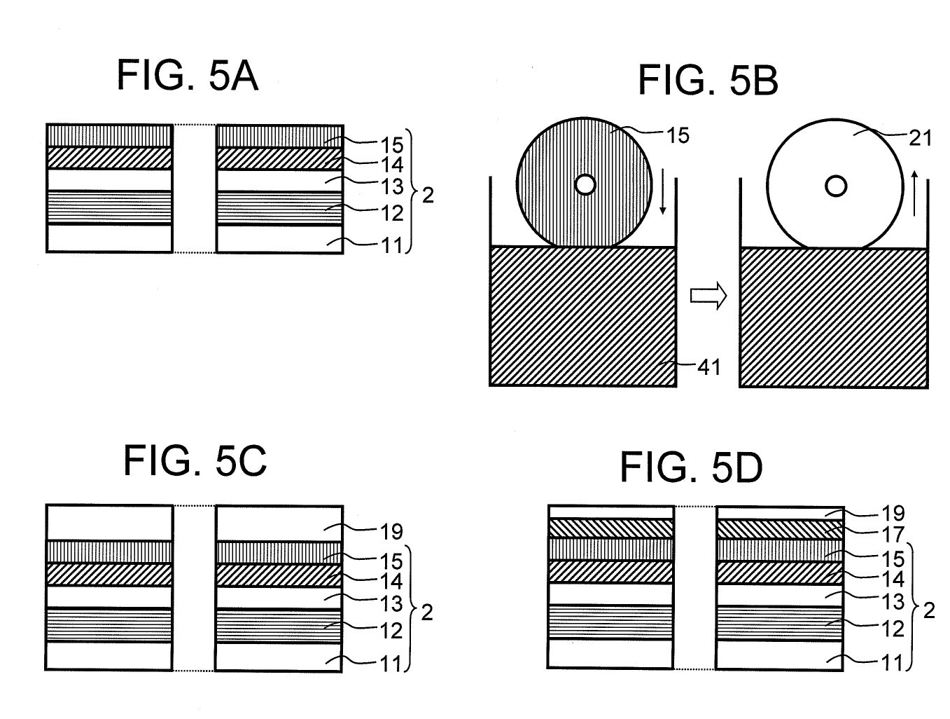

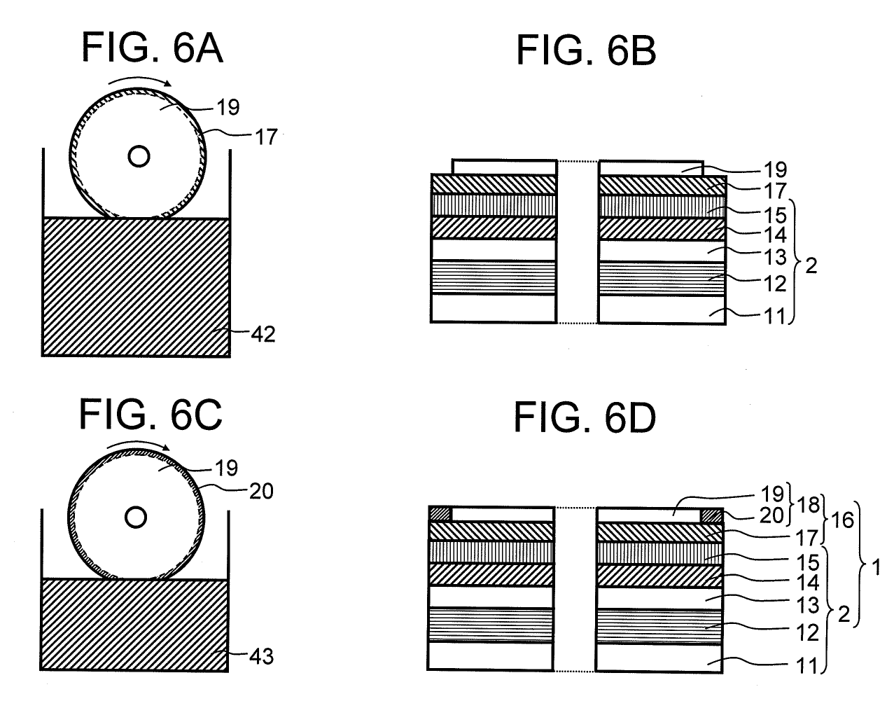

Each of these steps will be described below with reference to FIGS. 5A to 5D and FIGS. 6A to 6D. FIGS. 5A to 5D and FIGS. 6A to 6D are schematic views illustrating the steps of the method for manufacturing a storage medium according to an embodiment shown in FIG. 4. The above-described matters concerning the storage medium will not be further described.

### (First Step: the Step of Providing a Medium Plate Member)

A first step is the step of providing a medium plate member that includes a magnetic storage medium layer disposed on at least one side of a substrate and a protective layer for protecting the magnetic storage medium layer.

The substrate may be appropriately selected from the nonmagnetic substrates described above. The substrate may be appropriately manufactured or may be a commercial product.

In addition to the storage medium layer, the soft under layer, the intermediate layer, and the protective layer described above may be placed over the substrate. For example, as illustrated in FIG. 5A, a medium plate member 2 includes a nonmagnetic substrate 11/a soft under layer 12/an intermediate layer 13/a storage medium layer 14/a protective layer 15. Each of these layers may be formed by any means, including sputtering, electrodeposition, and (alternating current) plating, as described above in the embodiment of the storage medium.

### (Second Step: the Step of Forming a First Lubricating Layer)

The second step is the step of forming a fluid first lubricating layer on the medium plate member provided in the first step. The material of the fluid first lubricating layer may be appropriately selected from the materials described above for the first lubricating layer in the magnetic storage medium described as the embodiment of the storage medium.

The first lubricating layer may be formed by any means, including dipping. In the dipping method, as illustrated in FIG. 5B, a lubricant solution 41 for forming the first lubricating layer is applied to the protective layer 15 by dipping the medium plate member 2 in the lubricant solution 41 and then pulling up the medium plate member 2. In place of pulling up the medium plate member 2, the level of the lubricant solution 41 may be lowered. The dipping method is suitable for mass production and can control the film thickness easily. The dipping method can also achieve a uniform thickness. In place of dipping, spin coating or spray coating may be used. As illustrated in FIG. 5B, the second step provides a first lubricating layer 19 disposed on the medium plate member 2.

### (Third Step: the Step of Forming a Fixed Layer)

The third step is the step of forming a fixed layer to bring the medium plate member into intimate contact with the first lubricating layer formed in the second step. The material of the fixed layer 17 is preferably a lubricant having a polar group, as described above for the fixed layer 17 of the storage medium according to the embodiment described above.

The fixed layer 17 may be formed by heat-treating (baking) the medium plate member 2 and the first lubricating layer 19 formed in the second step. The heat treatment fixes a portion of the first lubricating layer 19 in contact with the medium plate member 2 on the protective layer 15 by intermolecular interaction. This fixed portion is the fixed layer 17. FIG. 5D illustrates a medium plate member that includes the fixed layer 17 formed in the third step. The fixed layer 17 underlies the first lubricating layer 19, which has weak intermolecular interaction with the protective layer 15.

In a method for manufacturing a storage medium according to the embodiment, the first lubricating layer 19 may be formed on the fixed layer 17 after the fixed layer 17 is formed on the medium plate member 2. In this case, the fixed layer 17 and the first lubricating layer 19 may be formed of different materials. While the heat treatment is performed in the present embodiment, the fixed layer 17 may be formed by leaving the fixed layer 17 stand at normal temperature without heat treatment.

### (Fourth Step: the Step of Removing an Outer Area of the First Lubricating Layer)

The fourth step is the step of removing at least part of an outer area of the first lubricating layer formed in the second step. As illustrated in FIG. 6A, the at least part of an outer area of the first lubricating layer may be removed by dipping only the part to be removed, which corresponds to an outer area of a data area of a magnetic disc, in a solvent 42 while rotating the medium plate member, and then rinsing the first lubricating layer 19 formed in the second step. The solvent 42 may be any solvent that can dissolve the first lubricating layer 19, for example, a fluorinated solvent or pure water. Examples of the fluorinated solvent include commercially available solvents, such as FC77, FC3255, and HFE7300 (manufactured by 3M Co.), Vertrel-XF (manufactured by Du Pont), and H-Galden (manufactured by Solvay Solexis). When the solvent is a fluorinated solvent, the solvent is preferably kept at a temperature in the range of about 20° C. to 25° C. to prevent its volatilization. FIG. 6B is a schematic cross-sectional view of a medium plate member prepared in the fourth step, in which the outer area of the first lubricating layer is removed.

In FIG. 6B, all the outer area of the first lubricating layer is removed. However, in a method for manufacturing a storage medium according to the present invention, part of the outer area of the first lubricating layer may be left in the fourth step. In a method for manufacturing a storage medium according to the present invention, an outer area of the fixed layer may be entirely or partly removed in the fourth step.

### (Fifth Step: the Step of Forming a Second Lubricating Layer in the Outer Area)

The fifth step is the step of forming a second lubricating layer in the outer area from which the first lubricating layer is removed. The material of the second lubricating layer may be appropriately selected from the compounds described above for the second lubricating layer 20 of the magnetic storage medium, which is the embodiment of the storage medium.

The second lubricating layer may be formed by any means and is preferably formed by dipping in terms of productivity. The second lubricating layer is formed by dipping only part of the medium plate member prepared in the fourth step that corresponds to an outer portion of a data area of a magnetic disc in a lubricant solution 43 for forming the second lubricating layer while rotating the medium plate member.

FIG. 6C is a schematic view illustrating a method for forming a second lubricating layer in an outer area by dipping the medium plate member illustrated in FIG. 6B. FIG. 6D illustrates a medium plate member that includes the second lubricating layer in the outer area prepared in the fifth step. The medium plate member is a magnetic storage medium according to the present embodiment.

### 3. Storage Device

In a storage device according to an embodiment, a storage device comprises: a storage medium having a substrate, a storage medium layer for storing information, a first lubricating layer on a first area of the storage medium layer, and a second lubricating layer on a second area of the storage medium, the second lubricating layer having a viscosity lower than the first lubricating layer; and a head for writing information into the storage medium layer or reading information from the storage medium layer.

In a storage device according to the embodiment, which includes a storage medium according to the embodiment, zero height detection can be performed precisely. The zero height detection is described above for the storage medium according to the embodiment. Precise zero height detection allows information to be stably recorded on and reproduced from the storage medium while the flying height of a head is maintained at a predetermined value during the operation of the storage device.

An embodiment of a storage device is described above with reference to FIG. 1, FIGS. 2A and 2B, and FIGS. 3A to 3D.

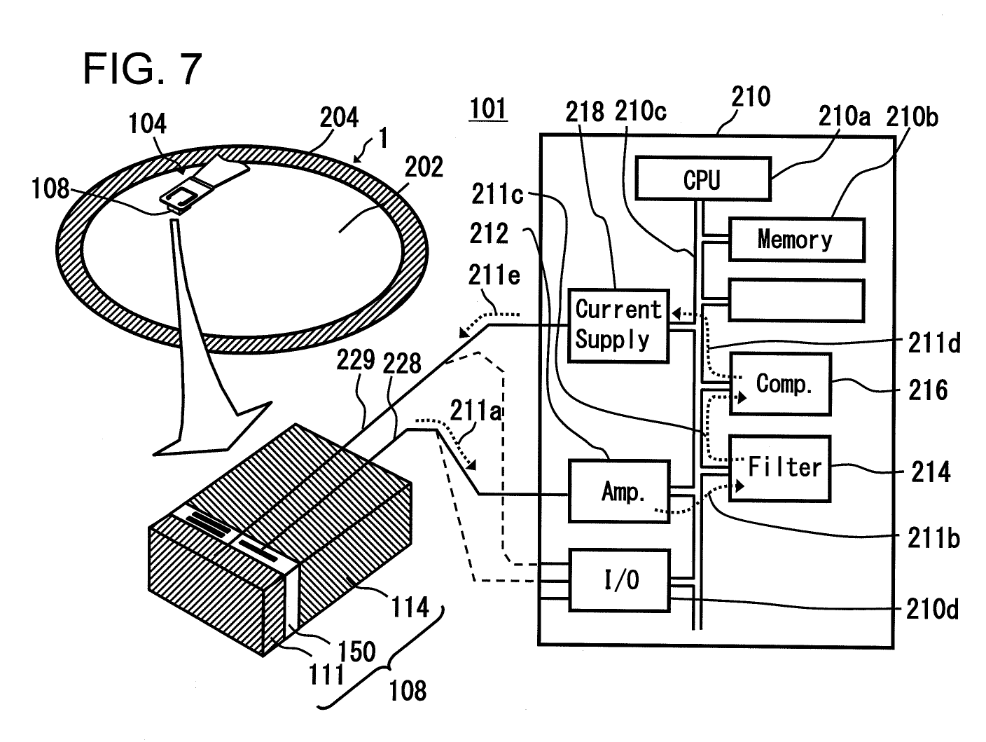

FIG. 7 shows a schematic structure of a magnetic disk drive according to an embodiment. As shown in FIG. 7, a head gimbal assembly 104 reads data from a magnetic disk 103 and writes data into the magnetic disk 103. The head gimbal assembly 104 includes a magnetic head 108. The magnetic head 108 includes an element member 111, a sensor 150, and a slider (slider substrate) 114 as shown in FIG. 1. The magnetic disk 103 has a storage region 202 capable of storing data and a non-storage region 204 in which data is not stored. The storage region 202 corresponds to the recording area 31 of storage medium 1 shown in FIG. 2. The non-storage region 204 corresponds to the area 32 designed for zero height detection in the magnetic storage medium 1 shown in FIG. 2.

The element member 111 reads data from the magnetic disk 103 and writes data into the magnetic disk 103, as described above. The element member 111 includes a read head element (not shown) that reads data from the magnetic disk 103 and a write head element (not shown) that writes data into the magnetic disk 103. The element member 111 also includes a heater (not shown) that produces heat by being supplied with a current so as to protrude a surface of the magnetic head 108 facing the magnetic disk 103. The heater is supplied with a current from a current supply circuit 218 in a controller 210. The heater produces heat in response to the amount of current supplied so as to expand the bottom of the magnetic head 108 facing the magnetic disk 103. The expansion of the bottom of the magnetic head 108 reduces the distance between the surface of the magnetic disk 103 and an end of the read head element adjacent to the magnetic disk 103 and between the surface of the magnetic disk 103 and an end of the write head adjacent to the magnetic disk 103. That is, the position of the element member 111 with respect to the surface of the magnetic disk 103 shifts in response to the amount of current (amount of energy) fed into the heater. In this case, the position of the magnetic head 108 with respect to the surface of the magnetic disk 103, i.e., the flying height of the slider, does not shift substantially. The amount of protrusion of the bottom of the magnetic head 108 is equal to the amount of displacement of the element member 111. A specific arrangement of the read head, the write head, and the heater will be described below.

As stated above, a part that changes the position of a magnetic head with respect to a magnetic disk is also referred to as an “actuator”.

The sensor 150 is disposed between the slider 114 and the element member 111. The sensor 150 converts mechanical vibration of the magnetic head 108 into an electric signal 211a. The electric signal 211a is transmitted to a signal amplifying circuit 212 in the controller 210 through a lead 228.

The controller 210 is mounted on, for example, a control board (not shown) that controls operations of a magnetic disk drive 101. As shown in FIG. 1, the controller 210 includes a central processing unit (CPU 210a), a memory 210b in which a program for controlling the CPU 210a is stored, and a bus 210c that transmits signals therebetween. The controller 210 controls operations of the magnetic disk drive 101. The controller 210 includes an input/output circuit 210d which is connected to the bus 210c and which sends a signal to the outside and receives a signal from the outside. The memory 210b includes a random-access memory (RAM) that temporarily stores data and a read-only memory (ROM) holding a program. Furthermore, the controller 210 includes the signal amplifying circuit 212, a filter circuit 214, a comparator circuit 216, and the current supply circuit 218 that are connected to the CPU 210a through the bus 210c.

The signal amplifying circuit 212 receives the electric signal 211a from the sensor 150 and then amplifies the electric signal 211a according to a command from the CPU 210a. Alternatively, the signal amplifying circuit 212 does not directly receive the electric signal 211a but may receive the electric signal 211a via the input/output circuit 210d. The amplified signal 211b is send to the filter circuit 214 through, for example, the bus 210c. For example, the signal amplifying circuit 212 amplifies the voltage level of the electric signal 211a while the S/N ratio of the electric signal 211a is maintained. The amplification operation of the electric signal 211a may be performed not by the command from the CPU 210a but with the comparator circuit 216 alone.

The filter circuit 214 receives the signal 211b from the sensor 150 and then filters the signal 211b. The filter circuit 214 sends the filtered signal 211c to the comparator circuit 216 through, for example, the bus 210c. For example, the filter circuit 214 filters out frequency components of several tens of kilohertz or less and frequency components of several megahertz or more to improve the S/N ratio of the amplified signal 211b. The filtering of the signal 211b may be performed not by a command from the CPU 210a but with the filter circuit 214 alone.

The comparator circuit 216 receives the signal 211c from the filter circuit 214. The comparator circuit 216 compares a peak value of the signal 211c with a reference value according to a command from the CPU 210a. The comparator circuit 216 provides a notification 211d of the comparison result to the current supply circuit 218. Specifically, when the peak value of the signal 211c is larger than the predetermined reference value, the notification 211d is made to the current supply circuit 218. The notification 211d to the current supply circuit 218 is made through, for example, the bus 210c. The comparison of the peak value of the signal 211c with the reference value may be performed not by a command from the CPU 210a but with the comparator circuit 216 alone.

The term “reference value” defined here refers to a value determined by actual measurement of a plurality of magnetic disk drives 101 that are of the same type. Specifically, in each of the magnetic disk drives 101 prepared, the element member 111 is brought into contact with a surface of the magnetic disk 103. The signal 211c is measured before contact. Then the signal 211c is measured when the element member 111 is in contact with the surface of the magnetic disk 103. A frequency component of the signal 211c having a largest change in peak value is determined from the measurement results. A substantially intermediate value between the peak value before contact and the peak value of the determined frequency component when the element member 111 is in contact with the surface of the magnetic disk 103 is defined as the reference value. Alternatively, the reference value may be determined by a simulation. In addition, the reference value may be determined by the use of the magnetic disk drive 101 in which the flying height of the element member 111 will be adjusted. In this case, for example, the housing (not shown) of the magnetic disk drive 101 is provided with a small transparent window (not shown). After the completion of the magnetic disk drive 101, vibration of the element member 111 is observed through the transparent window in order to determine when the element member 111 comes into contact with the magnetic disk 103. In the case where vibration of the element member 111 is observed through the transparent window, a measuring apparatus, such as a laser Doppler vibrometer that irradiates an object with laser light and measures a relative velocity on the basis of the phase difference of the reflected light may be used.

The current supply circuit 218 receives the notification 211d from the comparator circuit 216 and then limits the value of a current 211e fed into the heater. For example, the ROM in the controller 210 stores the relationship between the current 211e fed into the heater and the flying height of the element member 111. The relationship between the current 211e fed into the heater and the flying height of the element member 111 is desirably obtained by measurement with the magnetic disk drive 101 in which the flying height will be adjusted. Thus, for example, the relationship is determined by automatically performing measurement immediately after power-on and writing the measurement result into the ROM at a predetermined address. Alternatively, the relationship determined by a simulation may be written from the outside into the ROM at a predetermined address. The CPU 210a may carry out all of these tasks on the basis of a program stored in the ROM. In addition, the current 211e fed into the heater may be a pulse current.

When the current supply circuit 218 receives the notification 211d from the comparator circuit 216, the current supply circuit 218 recognizes that the element member 111 is in contact with the surface of the magnetic disk 103. The current supply circuit 218 allows the value of current fed into the heater (for example, the value of the current 211e) when the current supply circuit 218 receives the notification to be temporarily stored into the RAM in the controller 210 according to a command from the CPU 210a. In the case where the current 211e fed into the heater is a pulse current, for example, the current supply circuit 218 regards the integral of the current per unit time as the value of the current 211e fed and allows the integral to be stored into the RAM. In addition, the CPU 210a may carry out all of the storage tasks on the basis of a program stored in the ROM. Then, according to commands from the CPU 210a, the current supply circuit 218 determines a current Is corresponding to an optimum flying height Hs from the value of the current 211e when the element member 111 is in contact with the surface of the magnetic disk 103, and sets the current fed into the heater to the current Is. When a read operation and a write operation are performed, the current Is is fed into the heater through a lead 229. In this case, the current 211e fed into the heater is not directly supplied from the current supply circuit 218 but may be supplied from the current supply circuit 218 via the input/output circuit 210d.

### Method for Adjusting Flying Height of Magnetic Head

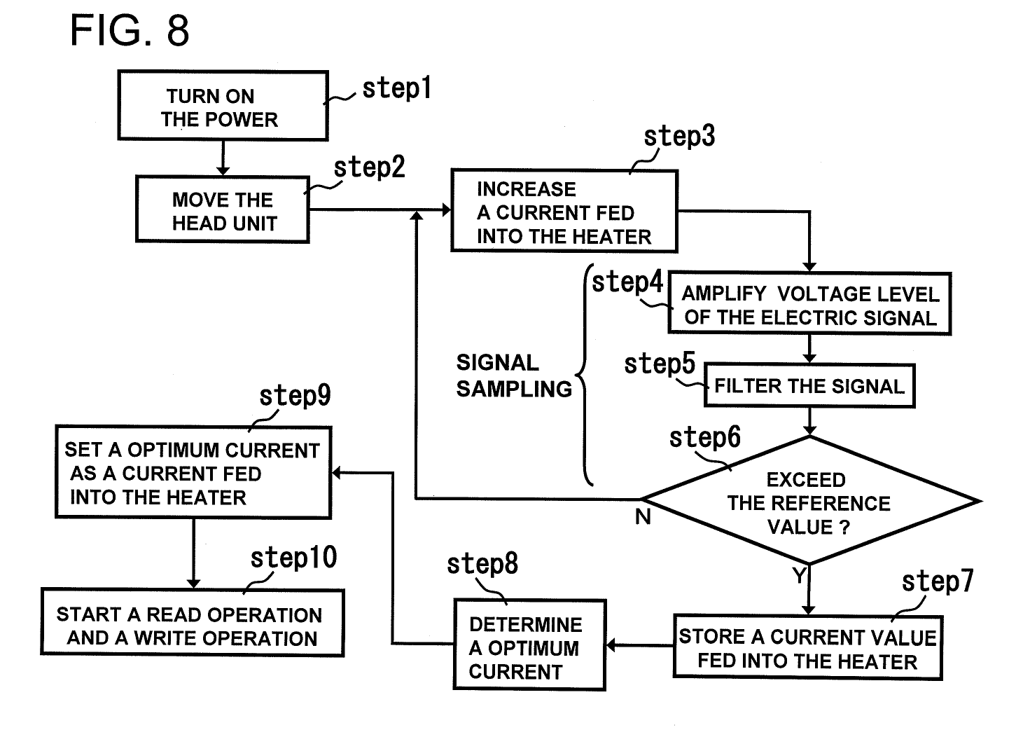

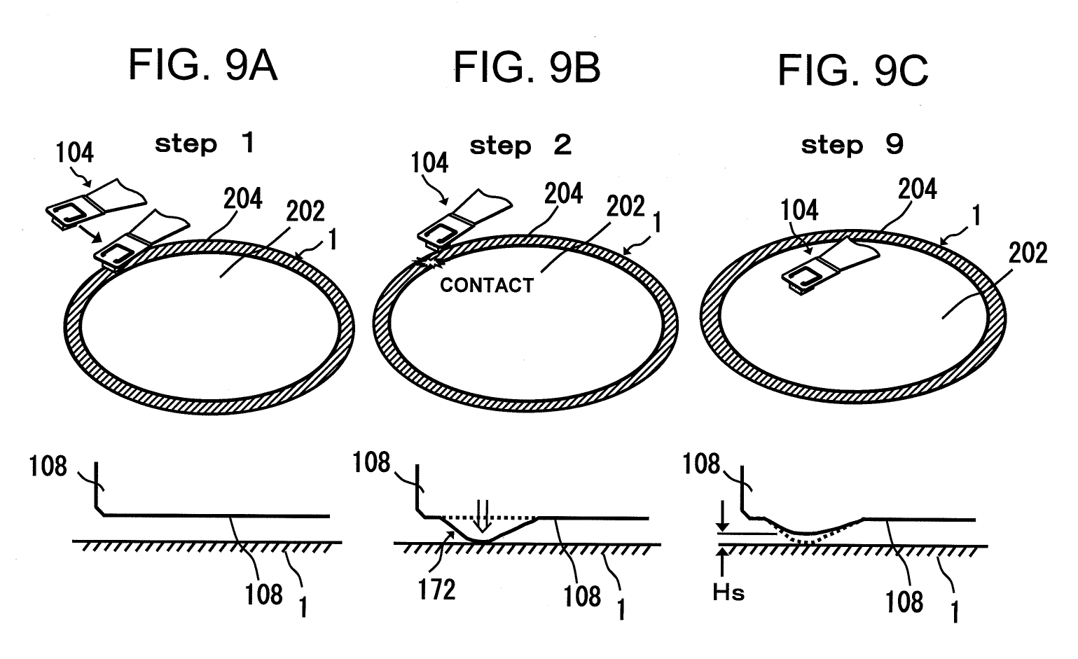

A method for adjusting the flying height of the magnetic head with the magnetic disk drive 101 shown in FIG. 7 will be described below. FIG. 8 is a flowchart of the method for adjusting the flying height of the magnetic head. FIGS. 9A to 9C show states of the head gimbal assembly 104 in main steps shown in the flowchart in FIG. 8.

### Step 1

The power to the magnetic disk drive 101 is turned on. Then the CPU 210a in the controller 210 rotates a spindle on which the magnetic disk 103 is mounted to rotate the magnetic disk 103.

### Step 2

The controller 210 moves the head gimbal assembly 104 in such a manner that the element member 111 is located directly above the non-storage region 204 of the magnetic disk 103. Specifically, for example, the head gimbal assembly 104 is moved in the direction of an arrow shown in FIG. 3A. The head gimbal assembly 104 may be moved before the rotation of the magnetic disk 103. Step 1 and 2 correspond to the step of allowing the magnetic head 108 to plane over the magnetic disk 103 in the zero height detection as illustrated in FIG. 3A

### Step 3

The CPU 210a increases a current fed into the heater in the element member 111 by a predetermined increment. A current equal to the predetermined increment is fed into the heater because the current fed into the heater is initially zero. In the case where this step is performed after step 6 is performed, the current fed into the heater is gradually increased. The heater protrudes the bottom 24b of the magnetic head 108 toward the magnetic disk 103 in response to the current fed. FIG. 9B shows this state. Although FIG. 9B shows the state (protrusion 172) in which the bottom 24b protrudes partially, a wider region of the bottom 24b may protrude. However, in each case, the most protruded portion preferably corresponds to the bottom of the element member 111.

### Step 4

The CPU 210a starts sampling the electric signal 211a from the sensor 150. The CPU 210a commands the signal amplifying circuit 212 to amplify the voltage level of the electric signal 211a from the sensor 150 and then to send the amplified signal 211b to the filter circuit 214.

### Step 5

The CPU 210a commands the filter circuit 214 to filter the signal 211b from the signal amplifying circuit 212 and then to send the filtered signal 211c to the comparator circuit 216. As described above, for example, the S/N ratio of the amplified signal 211b is improved by filtering out frequency components of several tens of kilohertz or less and frequency components of several megahertz or more. Alternatively, a plurality of magnetic disk drives 101 that are of the same type is tested in order to determine a frequency component required, and then frequency components other than the determined frequency component may be filtered out.

### Step 6

The CPU 210a allows the comparator circuit 216 to check whether the strength of the signal 211c exceeds the reference value. When the strength of the signal 211c does not exceed the reference value, the CPU 210a gives a command to return to Step 3. When the strength of the signal 211c exceeds the reference value, the CPU 210a commands the comparator circuit 216 to provide notification of an excess of the strength of the signal 211c over the reference value to the current supply circuit 218. Then the CPU 210a gives a command to go to Step 7. Alternatively, only when the strength of the signals 211c exceeds the reference value multiple times (e.g., three times) in succession, the process may go to step 7. This process ensures reliable determination impervious to noise. Steps 3 to 6 correspond to the step of forming the protrusion 112 in the zero height detection as illustrated in FIG. 3B.

### Step 7

The CPU 210a commands the current supply circuit 218 to store the current value Ic (collision energy E2) fed into a heater 170 when the strength of the signal 211c exceeds the reference value into the RAM in the memory 210b. Steps 7 corresponds to the step of the protrusion 112 being brought into contact with the magnetic disk 103 and the height information of the tip of the protrusion 112 in contact with the magnetic disk 103 being stored as the “zero” height in memory in the zero height detection as illustrated in FIG. 3C.

### Step 8

The CPU 210a determines the optimum current Is (optimum energy level E1) on the basis of the relationship between the current 211e fed into the heater and the flying height of the element member 111, the relationship being stored in the ROM in advance.

### Step 9

The CPU 210a commands the current supply circuit 218 to set the current 211e fed into the heater at the optimum current Is (optimum energy level E1) determined in Step 8.

### Step 10

The CPU 210a reads data (read operation) from the magnetic disk 103 and writes data (write operation) into the magnetic disk 103 while the optimum current Is is fed into the heater. FIG. 9C shows this state. Steps 8 to 10 correspond to the step of the length of the protrusion 112 being controlled to achieve a predetermined flying height H on the basis of the zero height stored in memory in the zero height detection as illustrated in FIG. 3D.

The flying height of the element member 111 is controlled through the above-described steps. The above-described control precisely adjusts the flying height of the magnetic head with respect to the surface of the magnetic disk. In the case where the relationship between the flying height of the element member 111 and the current 211e fed into the heater 170 in the read operation is different from that in the write operation, the adjustment of the flying height of the element member 111 in the read operation may be different from that in the write operation. Furthermore, in Steps 3 to 6, processing may be performed by each circuit without a command from the CPU 210a.

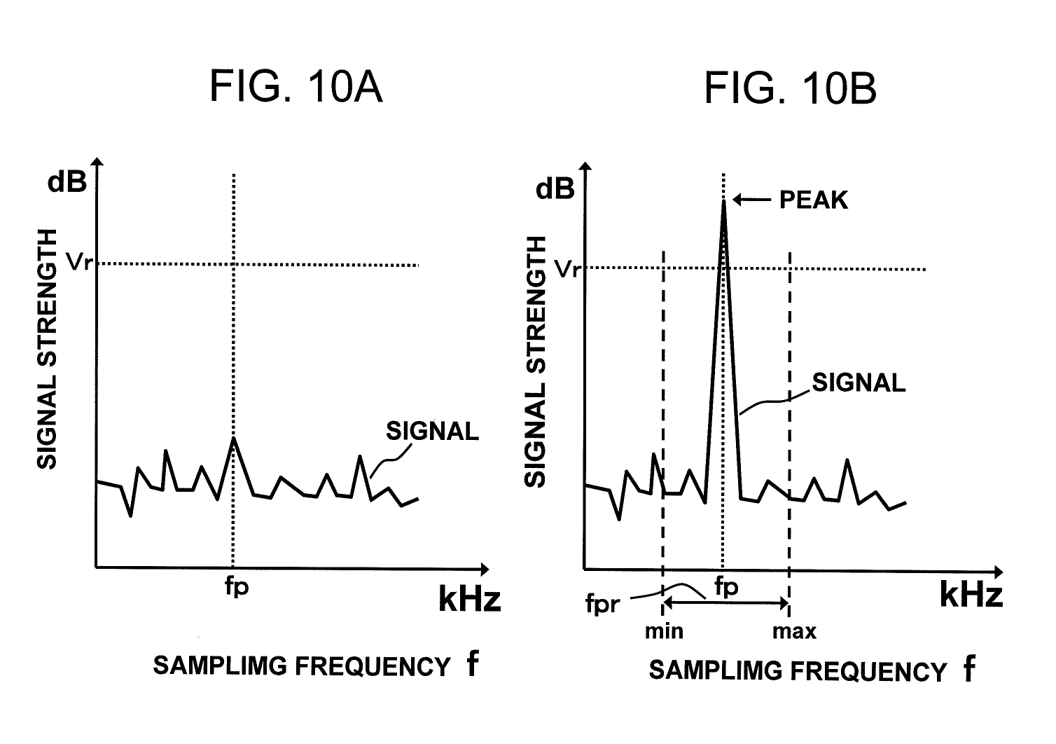

A method for detecting a point (reference point of the flying height) where the element member 111 is in contact with the magnetic disk 103 on the basis of a sampled signal waveform will be described below. FIGS. 10A and 10B are each a graph showing an example of a signal 211c supplied from a filter circuit 214. FIG. 10A shows a signal sampled before the element member 111 comes into contact with the magnetic disk 103. FIG. 10B shows a signal sampled immediately after the element member 111 comes into contact with the magnetic disk 103. In FIGS. 10A and 10B, the horizontal axis indicates the sampling frequency, and the vertical axis indicates the signal strength.

The contact between the element member 111 and the surface of the magnetic disk 103 steeply increases only a signal component having a predetermined frequency (fp). As a result, the peak value of the signal having the predetermined frequency fp exceeds the reference value. In this way, a frequency component that is maximized when the element member 111 is in contact with the magnetic disk 103 is defined as the predetermined frequency. The predetermined frequency fp is a value determined in response to, for example, the shape of the magnetic head 108. Thus, the predetermined frequency fp can vary slightly among devices that are of the same type. As shown in FIG. 10B, the minimum (min) and the maximum (max) of the variation range fpr of the predetermined frequency fp may be set.

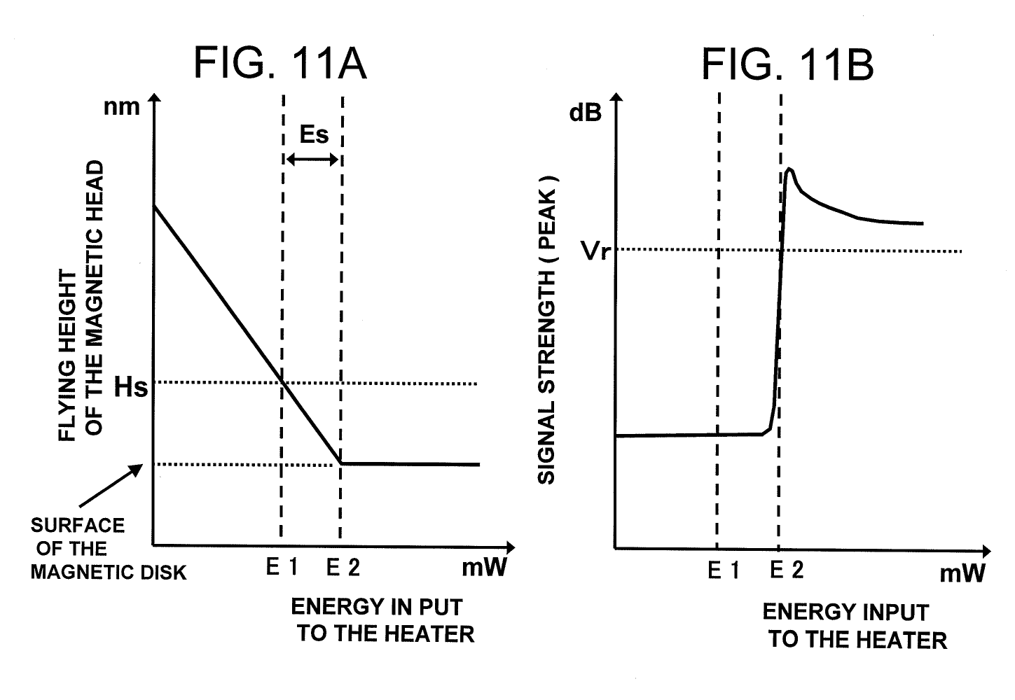

FIG. 11A is a graph showing the relationship between the energy input to the heater 170 and the flying height of the magnetic head, and FIG. 11B is a graph showing the relationship between the energy input to the heater 170 and the signal strength. The term “flying height of the magnetic head” refers to the flying height of the element member 111 with respect to the magnetic disk 103. The term “signal strength” refers to the signal strength of the predetermined frequency fp of the signal 211c. As shown in FIG. 11A, an increase in energy input to the heater 170 gradually reduces the flying height of the element member 111. When the energy input reaches E2, the flying height of the element member 111 is zero. That is, the bottom of the element member 111 (magnetic head 108) comes into contact with the surface of the magnetic disk 103. As shown in FIG. 11B, the signal strength (peak value) of the signal 211c increases steeply and exceeds the reference value Vr.

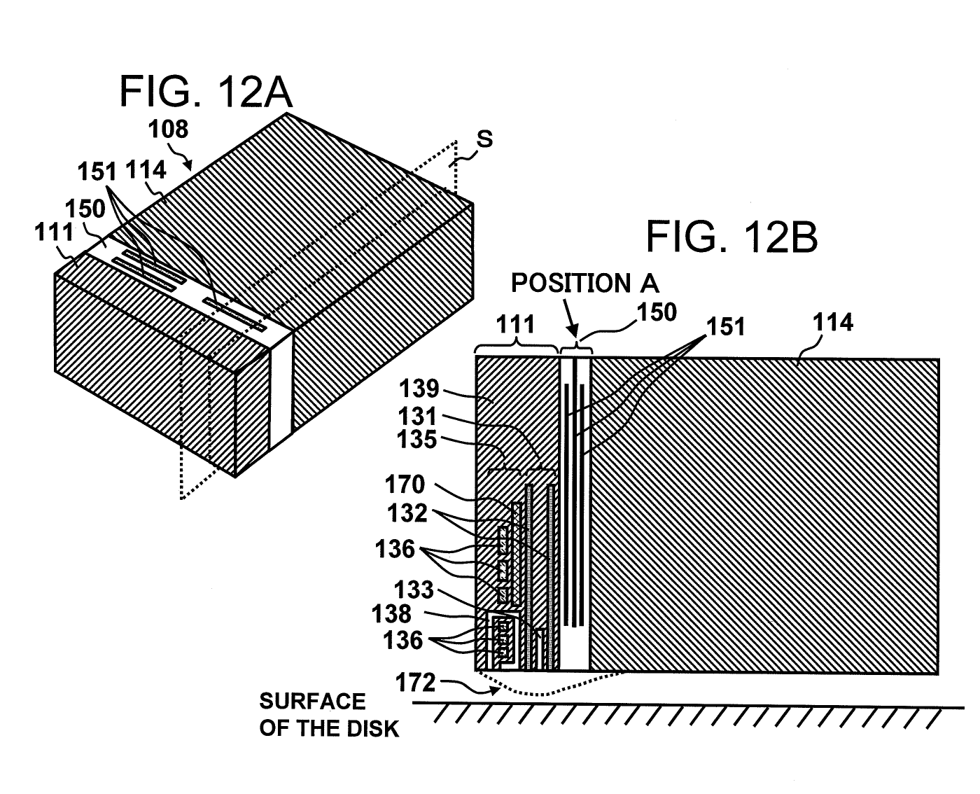

Examples of a structure in which the sensor 150 is mounted on the magnetic head 108 will be shown. FIGS. 12A and 6B each show an example of a structure in which the sensor 150 is disposed between the slider 114 and the element member 111 (position A). As shown in FIGS. 12A and 12B, the sensor 150 includes a plurality of electrodes for obtaining an electric signal. FIG. 12A is a perspective view of the magnetic head 108. FIG. 12B is a cross-sectional view of the magnetic head 108, viewed along the plane S. As shown in FIG. 12B, the element member 111 includes a read head element 131 and a write head element 135 therein. The read head element 131 includes two shield layers 132 and a read subelement between the shield layers 132. The write head element 135 includes a write coil 136 and a magnetic pole 138 magnetized by the write coil 136. The element member 111 further includes the heater 170 disposed between the write coil 136 and the magnetic pole 138. The main components (the read head element 131, the write head element 135, and the heater 170) of the magnetic head are covered with a protective film 139 as shown in FIG. 12B.

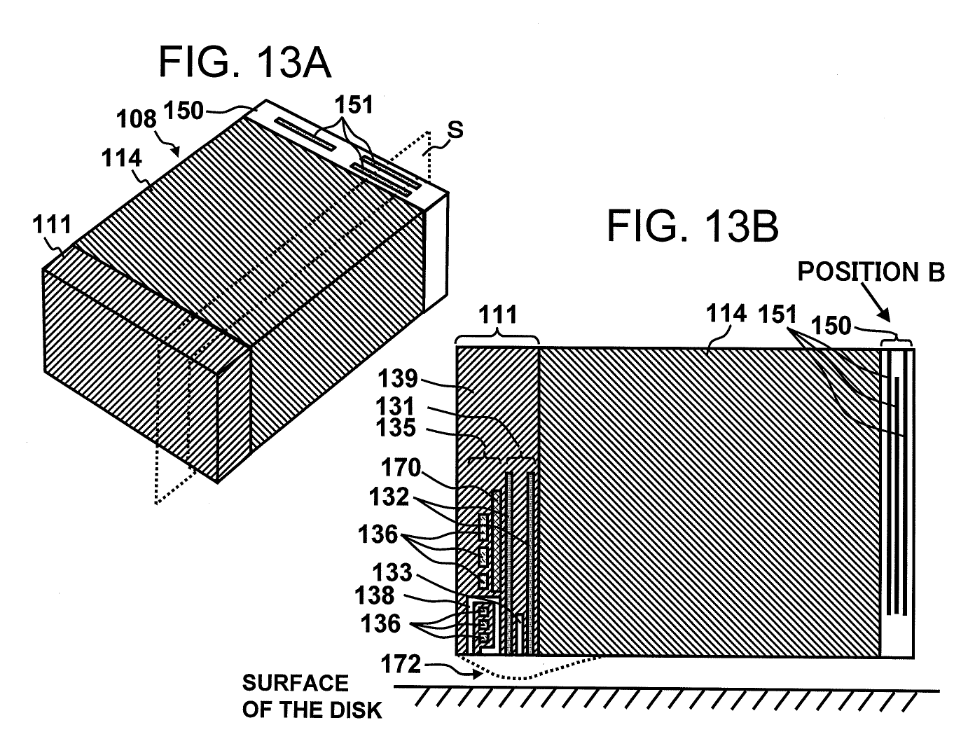

FIGS. 13A and 13B each show an example of a structure in which the sensor 150 is disposed on a side (position B) of the slider 114 opposite the side adjacent to the element member 111. FIG. 13A is a perspective view of the magnetic head 108. FIG. 13B is a cross-sectional view of the magnetic head 108, viewed along the plane S. The structure in the element member 111 is the same as in FIGS. 13A and 13B, and redundant description is not repeated.

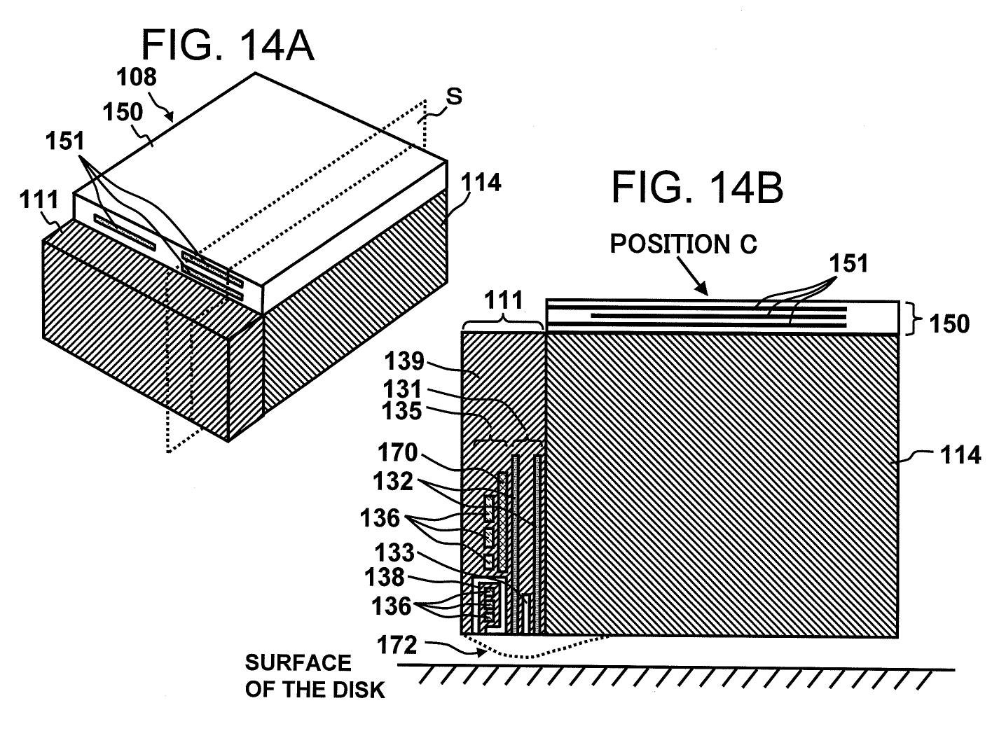

FIGS. 14A and 14B each show an example of a structure in which the sensor 150 is disposed on the top face (position C) of the slider 114. FIG. 14A is a perspective view of the magnetic head 108. FIG. 14B is a cross-sectional view of the magnetic head 108, viewed along the plane S. The structure in the element member 111 is the same as in FIGS. 14A and 14B, and redundant description is not repeated. When the sensor 150 is disposed at position C, the sensor 150 can have a large area compared with the case where the sensor 150 is disposed at positions A or B. Thus, the structure is advantageous in that sensitivity to a signal (S/N ratio) can be increased because vibration of the magnetic head 108 can be detected with the large-area sensor. FIGS. 14A and 14B each show the example of the structure in which the electrodes of the sensor 150 are located on the element member 111 side. When a space around the element member 111 is not easily ensured because of the presence of leads from the element member 111, the electrodes may be located on a side opposite the element member 111 side.

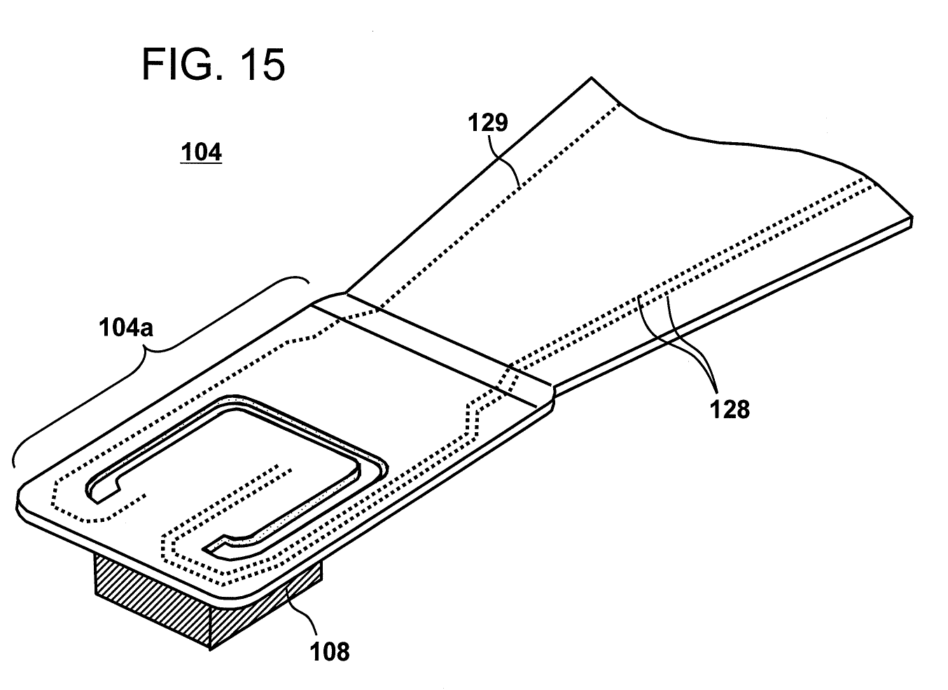

FIG. 15 is an enlarged view of the head gimbal assembly 104. The magnetic head 108 is mounted on an end of the head gimbal assembly 104. As shown in FIG. 15, for example, the leads 228 and 229 from the magnetic head 108 are disposed on the undersurface of the head gimbal assembly and electrically connects between a plurality of electrodes (not shown) disposed on the magnetic head 108 and the controller 210. A flexible wiring board (not shown) provided with the leads 228 and 229 may be attached to the head gimbal assembly 104 instead of the leads 228 and 229 directly formed on the undersurface of the head gimbal assembly 104.

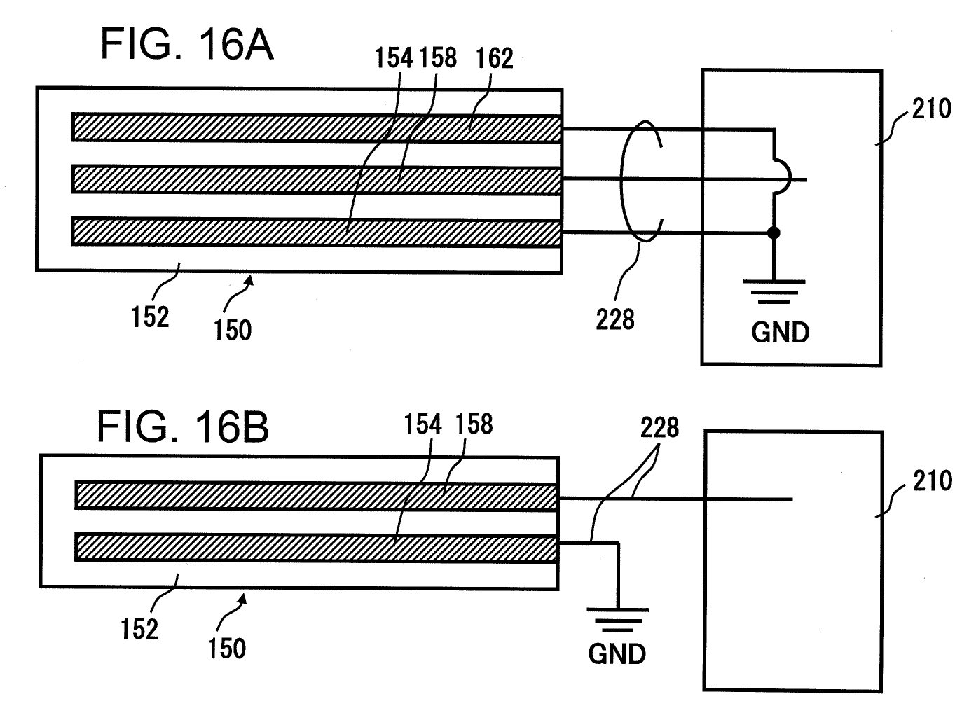

FIGS. 16A and 16B each show a basic structure of the sensor 150. As shown in FIG. 16A, the sensor 150 is composed of electrodes 154, 158, and 162 and an insulating layer 152. As described above, the insulating layer 152 is composed of an insulating material, such as aluminum nitride, having piezoelectricity. FIG. 16B shows an example of a structure in which a single electrode is grounded.

As shown in FIG. 16A, the electrodes 154 and 162 may be connected to the lead 228 extending from the controller 210 to establish a ground. Alternatively, as shown in FIG. 16B, the electrode 154 may be connected to a position other than the controller 210 to establish a ground.

The magnetic head 108 illustrated in FIG. 1 corresponds to a head of a storage device according to the present invention. A head of a storage device according to the present invention is not limited to a magnetic head and may vary with the type of storage medium. For a method for manufacturing a storage device, refer to known techniques.

A storage medium, a method for manufacturing a storage medium, and a storage device according to the present invention are not limited to the embodiments described above. The embodiments described above are provided only for illustrative purposes. Other embodiments that are based on substantially the same technical idea as that described in the claims of the present invention and that have substantially the same operational advantages as those of the present invention are within the technical scope of the present invention.

A storage device according to the embodiment includes a storage medium that has a lubricating layer having a viscosity lower than known lubricating layers. Thus, the lubricating layer can absorb an impact of a head on the lubricating layer during zero height detection. This reduces the amplitude of vibrations of the head caused by the impact and accordingly improves the precision of zero height detection. Consequently, the flying height is controlled precisely, and information can be stably recorded on and reproduced from the storage medium.

### EXAMPLES

### Example 1

A medium plate member 2 illustrated in FIG. 5A was produced by forming a soft under layer formed of an antiferromagnetic material, such as Ru or a Ru alloy, an intermediate layer formed of a Ni alloy, a Ru alloy, or a CoCr alloy containing an oxide, and a storage medium layer formed of a ferromagnetic material, such as Co, Ni, Fe, a Co alloy, a Ni alloy, or an Fe alloy, by sputtering, and a protective layer formed of diamond-like carbon (DLC) by chemical vapor deposition (CVD) over a glass substrate having a diameter of 65 mm.

The medium plate member was then dipped in a treatment bath that contains a lubricant containing fluorinated materials having the following formulae (3) to (5) to apply a first lubricating layer to the protective layer, thus producing a medium plate member including a first lubricating layer 19, as illustrated in FIG. 5C.

R5-X1-R5 (3)

(wherein X1: —CF₂—O—(CF₂—CF₂—O)ₚ—(CF₂O)_{q}—CF₂—, p: 1100-1200, q: 1000-1100, and R5: —CH₂OCH₂CH(OH)CH₂OH)

R6-X1-R6 (4)

(wherein X1: —CF₂—O—(CF₂—CF₂—O)ₚ—(CF₂O)_{q}—CF₂—, p: 1100-1200, q: 1000-1100, and R6: —CH₂OH)

R7-X1-R7 (5)

(wherein X1: —CF₂—O—(CF₂—CF₂—O)ₚ—(CF₂O)_{q}—CF₂—, p: 1100-1200, q: 1000-1100, and R7: —F)

The ratio of the fluorinated materials having the formulae (3), (4), and (5) was 94.0%, 5.7%, and 0.3% by weight. The viscosity of the first lubricating layer 19 was 2.78 Pa·s. The viscosity was measured with a viscoelasticity measuring apparatus (REOLOGICA Instruments, Inc., trade name “VAR-100”). The viscosities of Examples and Comparative Examples described below were also measured in the same way.

The medium plate member including the first lubricating layer 19 was then heated in a furnace at 130° C. for 48 minutes to produce a medium plate member including a fixed layer 17 illustrated in FIG. 5D.

As illustrated in FIG. 6A, an outer area of the medium plate member including a fixed layer 17, which corresponds to an outer area of a data area of a magnetic disk, was then dipped in Vertrel-XF at a temperature in the range of 20° C. to 25° C. while being rotated. As illustrated in FIG. 6B, an outer area of the first lubricating layer 19 was removed.

As illustrated in FIG. 6C, the medium plate member was then dipped in a treatment bath that contains a lubricant containing fluorinated materials having the following formulae (6) to (8) while being rotated to form a second lubricating layer 20 in the outer area on the fixed layer 17. Thus, a magnetic storage medium according to Example 1 was prepared.

R5-Y1-R5 (6)

(wherein Y1: —CF₂—O—(CF₂—CF₂—O)ₚ—(CF₂O)_{q}—CF₂—, p: 400-500, q: 400-500, and R5: —CH₂OCH₂CH(OH)CH₂OH)

R6-Y1-R6 (7)

(wherein Y1: —CF₂—O—(CF₂—CF₂—O)ₚ—(CF₂O)_{q}—CF₂—, p: 400-500, q: 400-500, R6: —CH₂OH, p: 1100-1200, and q: 1000-1100)

R7-Y1-R7 (8)

(wherein Y1: —CF₂—O—(CF₂—CF₂—O)ₚ—(CF₂O)_{q}—CF₂—, p: 400-500, q: 400-500, and R7:—F)

The ratio of the fluorinated materials having the formulae (6), (7), and (8) was 17.1%, 80.6%, and 2.3% by weight. The viscosity of the second lubricating layer 20 was 0.13 Pa·s.

### Example 2

Fluorinated materials having the following formulae (9) to (11) were used in place of the fluorinated materials having the formulae (6) to (8).

R—Y2-R5 (9)

(wherein Y2: —CF₂—O—(CF₂—CF₂—O)ₚ—(CF₂O)_{q}—CF₂—, p: 450-550, q: 350-450, and R5: —CH₂OCH₂CH(OH)CH₂OH)

R6-Y2-R6 (10)

(wherein Y2: —CF₂—O—(CF₂—CF₂—O)ₚ—(CF₂O)_{q}—CF₂—, p: 450-550, q: 350-450, and R6: —CH₂OH)

R7-Y2-R7 (11)

(wherein Y2: —CF₂—O—(CF₂—CF₂—O)ₚ—(CF₂O)_{q}—CF₂—, p: 450-550, q: 350-450, and R7: —F)

The ratio of the fluorinated materials having the formulae (9), (10), and (11) was 66.2%, 33.3%, and 0.5% by weight. The viscosity of the second lubricating layer 20 was 0.47 Pa·s.

A magnetic storage medium according to Example 2 was produced as in Example 1, except for the fluorinated materials.

### Example 3

Fluorinated materials having the following formulae (12) to (14) were used in place of the fluorinated materials having the formulae (6) to (8).

R5-Y3-R5 (12)

(wherein Y3: —CF₂—O—(CF₂—CF₂—O)ₚ—(CF₂O)_{q}—CF₂—, p: 1250-1350, q: 1250-1350, and R5: —CH₂OCH₂CH(OH)CH₂OH)

R6-Y3-R6 (13)

(wherein Y3: —CF₂—O—(CF₂—CF₂—O)ₚ—(CF₂O)_{q}—CF₂—, p: 1250-1350, q: 1250-1350, and R6: —CH₂OH)

R7-Y3-R7 (14)

(wherein Y3: —CF₂—O—(CF₂—CF₂—O)ₚ—(CF₂O)_{q}—CF₂—, p: 450-550, q: 350-450, and R7: —F)

The ratio of the fluorinated materials having the formulae (12), (13), and (14) was 77.0%, 22.0%, and 1.0% by weight. The viscosity of the second lubricating layer 20 was 0.61 Pa·s.

A magnetic storage medium according to Example 3 was produced as in Example 1, except for the fluorinated materials.

### Example 4

Fluorinated materials having the following formulae (15) to (17) were used in place of the fluorinated materials having the formulae (6) to (8).

R5-Y4-R5 (15)

(wherein Y4: —CF₂—O—(CF₂—CF₂—O)ₚ—(CF₂O)_{q}—CF₂—, p: 1700-1800, q: 1700-1800, and R5: —CH₂OCH₂CH(OH)CH₂OH)

R6-Y4-R6 (16)

(wherein Y4: —CF₂—O—(CF₂—CF₂—O)ₚ—(CF₂O)_{q}—CF₂—, p: 1700-1800, q: 1700-1800, and R6: —CH₂OH)

R7-Y4-R7 (17)

(wherein Y4: —CF₂—O—(CF₂—CF₂—O)ₚ—(CF₂O)_{q}—CF₂—, p: 1700-1800, q: 1700-1800, and R7: —F)

The ratio of the fluorinated materials having the formulae (15), (16), and (17) was 47.5%, 52.0%, and 0.5% by weight. The viscosity of the second lubricating layer 20 was 0.61 Pa·s.

A magnetic storage medium according to Example 4 was produced as in Example 1, except for the fluorinated materials.

### Example 5

Fluorinated materials having the following formulae (18) to (20) were used in place of the fluorinated materials having the formulae (6) to (8).

R5-Y5-R5 (18)

(wherein Y5: —CF₂—O—(CF₂—CF₂—O)ₚ—(CF₂O)_{q}—CF₂—, p: 1000-1100, q: 1000-1100, and R5: —CH₂OCH₂CH(OH)CH₂OH)

R6-Y5-R6 (19)

(wherein Y5: —CF₂—O—(CF₂—CF₂—O)ₚ—(CF₂O)_{q}—CF₂—, p: 1000-1100, q: 1000-1100, and R6: —CH₂OH)

R7-Y5-R7 (20)

(wherein Y5: —CF₂—O—(CF₂—CF₂—O)ₚ—(CF₂O)_{q}—CF₂—, p: 1000-1100, q: 1000-1100, and R7: —F)

The ratio of the fluorinated materials having the formulae (18), (19), and (20) was 59.3%, 39.9%, and 0.8% by weight. The viscosity of the second lubricating layer 20 was 0.94 Pa·s.

A magnetic storage medium according to Example 5 was produced as in Example 1, except for the fluorinated materials.

### Comparative Example 1

A medium plate member 2 illustrated in FIG. 5A was formed as in Example 1.

The medium plate member was then dipped in a treatment bath that contains a lubricant containing fluorinated materials having the following formulae (3) to (5) to apply a first lubricating layer to the protective layer, thus producing a medium plate member including a first lubricating layer 19, as illustrated in FIG. 5C.

R5-X1-R5 (3)

(wherein X1: —CF₂—O—(CF₂—CF₂—O)ₚ—(CF₂O)_{q}—CF₂—, p: 1100-1200, q: 1000-1100, and R5: —CH₂OCH₂CH(OH)CH₂OH)

R6-X1-R6 (4)

(wherein X1: —CF₂—O—(CF₂—CF₂—O)ₚ—(CF₂O)_{q}—CF₂—, p: 1100-1200, q: 1000-1100, and R6: —CH₂OH)

R7-X1-R7 (5)

(wherein X1: —CF₂—O—(CF₂—CF₂—O)ₚ—(CF₂O)_{q}—CF₂—, p: 1100-1200, q: 1000-1100, and R7: —F)

The ratio of the fluorinated materials having the formulae (3), (4), and (5) was 94.0%, 5.7%, and 0.3% by weight. The viscosity of the first lubricating layer 19 was 2.78 Pa·s.

The medium plate member including the first lubricating layer 19 was then heated in a furnace at 130° C. for 48 minutes to produce a medium plate member including a fixed layer 17 illustrated in FIG. 5D. Thus, a magnetic storage medium according to Comparative Example 1 was prepared. Since the magnetic storage medium according to Comparative Example 1 had no second lubricating layer, zero height detection of a magnetic head described below was performed on a portion of the first lubricating layer 19 that corresponds to the second lubricating layer 20 in Examples 1 to 5.

### (Evaluation)

### 1. Relationship Between Displacement D and Viscosity η in the Zero Height Detection of a Magnetic Head

Zero height detection of magnetic recording media prepared in Example 1 and Comparative Example 1 was performed in a magnetic storage device illustrated in FIG. 1. A magnetic head 108 of the magnetic storage device was provided with a heater 113 for heating an element 111, as illustrated in FIG. 3. While the heater 113 was heated to increase the protrusion of the element 111, the magnetic head 108 was brought into contact with the second lubricating layer 20 of the magnetic storage medium, which rotates at a predetermined number of revolutions. The displacement (amplitude) of vibrations was measured with a laser Doppler vibrometer (LDV) (manufactured by Denshigiken Co., trade name “V1002”) for 0.2 seconds when the magnetic head 108 came into contact with the second lubricating layer 20.

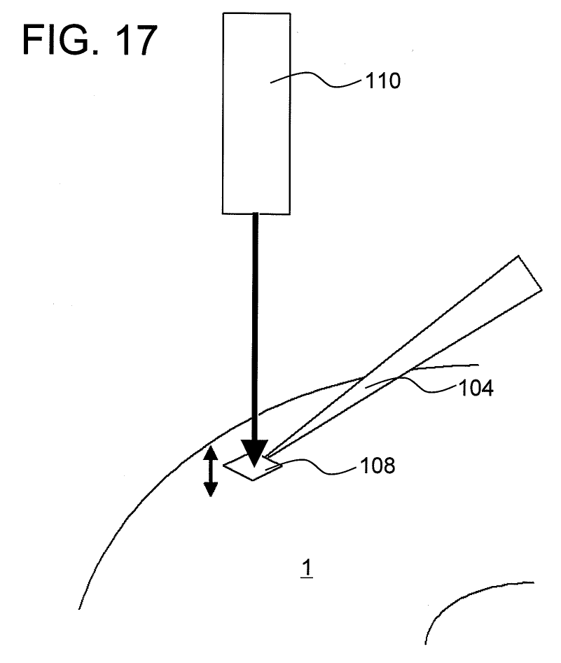

FIG. 17 is a schematic view illustrating means to measure the displacement of vibrations. The magnetic head 108 was perpendicularly irradiated with a laser beam emitted from the V1002. A Doppler signal reflected by the magnetic head 108 was detected by the V1002. The signal was frequency-resolved. A signal intensity at a predetermine frequency was output as the displacement of the magnetic head 108. The observed direction of vibrations of the magnetic head 108 was perpendicular to the surface of the magnetic storage medium.

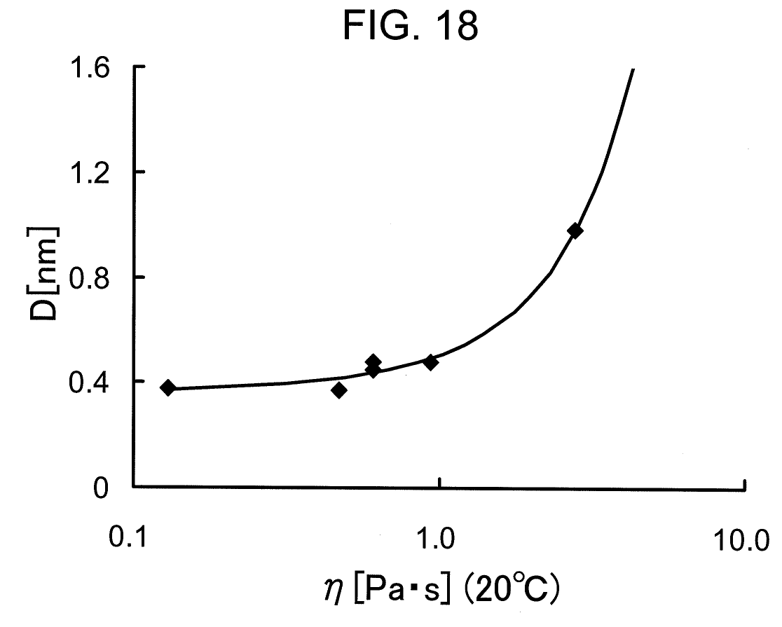

FIG. 18 shows the displacement of the magnetic head 108 in zero height detection as a function of the viscosity of the second lubricating layer 20. The horizontal axis represents the viscosity η (Pa·s) of the second lubricating layer 20, and the vertical axis represents the displacement D (nm) of the magnetic head 108. The displacement D of the magnetic head 108 in the magnetic recording media prepared in Examples 1 to 5 was 0.5 nm or less. By contrast, the displacement D of the magnetic head 108 in the magnetic storage medium prepared in Comparative Example 1 was 0.98 nm, which was about two to three times that in Examples 1 to 5.

### 2. Relationship Between Contamination of Magnetic Head and Viscosity

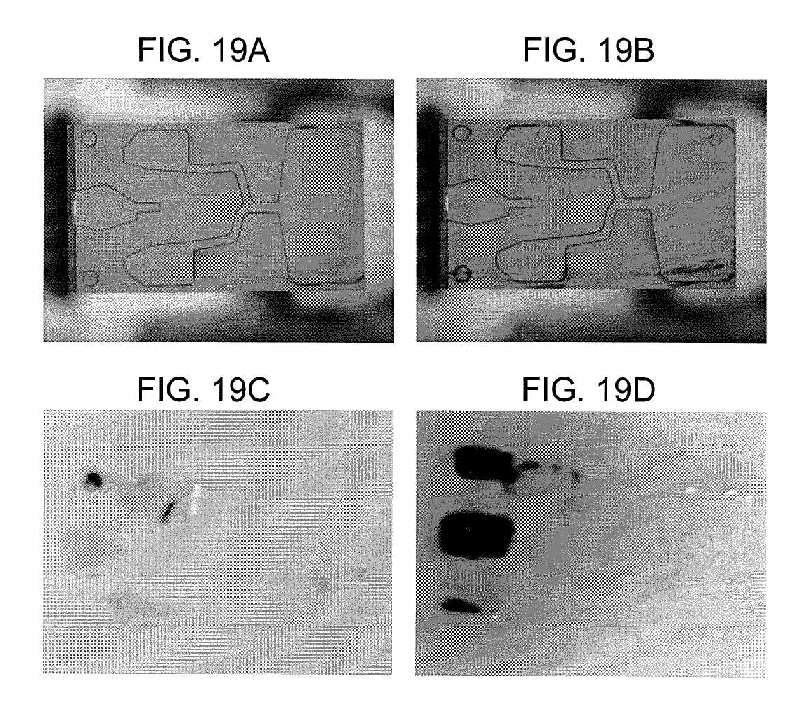

A head seek operation was performed over the first lubricating layer 19 at a reduced pressure of about 300 hPa for a predetermined period of time in the magnetic storage medium prepared in Example 1 installed in the magnetic storage device illustrated in FIG. 1. FIG. 19A shows a microphotograph of a magnetic head 108 after head seek. A portion of the first lubricating layer 19 transferred to the magnetic head 108 was transferred to a substrate. The substrate was then analyzed by ellipsometry with an optical surface analyzer (OSA) (Candela Instruments, Inc., trade name “OSA6100”). FIG. 19C shows the OSA image obtained. A method of transferring to the substrate is described in paragraph numbers 0034 to 0036 in Japanese Laid-open Patent Publication No. 2008-140478 (Japanese patent application No. 2006-326176). The substrate had the same structure as the medium plate member 2 described above. The transfer time was 30 minutes, and the transfer temperature was in the range of 20° C. to 25° C. The ellipsometry is described in paragraph numbers 0038 and 0039 in Japanese Laid-open Patent Publication No. 2008-140478 (Japanese patent application No. 2006-326176). Deeper in color of an OSA image indicates that a greater amount of lubricant is transferred from the first lubricating layer 19 to the magnetic head 108; that is, the magnetic head 108 is more contaminated. FIG. 19C shows that the head seek over the first lubricating layer 19 produced a small deep-color area in the OSA image, indicating that the magnetic head 108 is not significantly contaminated.

A head seek operation was also performed over the second lubricating layer 20 at a reduced pressure of about 300 hPa for the same period of time as described above in the magnetic storage medium prepared in Example 1 installed in the magnetic storage device illustrated in FIG. 1. FIG. 19B shows a microphotograph of the magnetic head 108 after head seek. A portion of the second lubricating layer 20 transferred to the magnetic head 108 was transferred to a substrate, and the substrate was analyzed by ellipsometry, as described above. FIG. 19D shows the OSA image obtained. FIG. 19D shows that the head seek over the second lubricating layer 20 produced a large deep-color area in the OSA image, indicating that the magnetic head 108 is significantly contaminated with the second lubricating layer 20.

If the first lubricating layer 19 is formed of the same material as the second lubricating layer 20 in Example 1, a large portion of the first lubricating layer 19 is probably transferred to the magnetic head 108, thus adversely affecting the magnetic recording and reproducing performance. In the magnetic storage medium prepared in Example 1, the magnetic head 108 generally reaches the second lubricating layer 20 only in the zero height detection. The second lubricating layer 20 is therefore rarely transferred to the magnetic head 108 in normal recording and reproducing operations.

What is claimed is:

1. A storage device comprising:
a storage medium having:
a substrate,
a storage medium layer for storing information on the substrate,
a first lubricating layer on a first area of the storage medium layer, and
a second lubricating layer on a second area of the storage medium, the second lubricating layer having a viscosity lower than the first lubricating layer; and
a head for writing information into the storage medium layer or reading information from the storage medium layer.

2. The storage device according to claim 1, wherein the second lubricating layer has a lubricant whose viscosity is equal to 1 Pa·s or less at 20° C.

3. The storage device according to claim 1, wherein the second lubricating layer contains a perfluoropolyether having an end group —CH₂OH and being free of end group—CH₂OCH₂CH(OH)CH₂OH, the perfluoropolyether being 80% or more by weight.

4. The storage device according to claim 1, wherein the first lubricating layer has viscosity equal to 4 Pa·s or more at 20° C.

5. The storage device according to claim 1, wherein the head includes:
an element member for writing information into the storage medium layer or reading information from the storage medium layer,
an actuator for changing the position of the head with respect to the storage medium; and
a sensor for detecting vibration of the head, the storage device further comprising a controller for detecting contact between the head and the second lubricating layer on the basis of the detected vibration and for controlling the actuator.

6. The storage device according to claim 5, wherein the actuator includes a heater for producing heat by being supplied with a current and thermally expanding the head so as to protrude a surface of the head facing the storage medium toward the storage medium side.

7. The storage device according to claim 6, wherein the sensor converts the detected vibration into an electric signal, and
the controller detects the amount of current through the heater on the basis of the electric signal when the head is in contact with the second lubricating layer, and then controls the flying height of the head with respect to the magnetic disk on the basis of the amount of current detected.

8. A storage medium comprising:
a substrate;
a storage medium layer for storing information on the substrate;
a first lubricating layer on a first area of the storage medium layer; and
a second lubricating layer on a second area of the storage medium, the second lubricating layer having a viscosity lower than the first lubricating layer.

9. The storage medium according to claim 8, wherein the second lubricating layer has a lubricant whose viscosity is equal to 1 Pa·s or less at 20° C.

10. The storage medium according to claim 8, wherein the second lubricating layer contains a perfluoropolyether having an end group —CH₂OH and being free of end group —CH₂OCH₂CH(OH)CH₂OH, the perfluoropolyether being 80% or more by weight.

11. The storage medium according to claim 8, the first lubricating layer has viscosity equal to 4 Pa·s or more at 20° C.

12. The storage medium according to claim 8, wherein the first lubricating layer contains a perfluoropolyether having an end group —CH₂OCH₂CH(OH)CH₂OH and being free of end group —CH₂OH, the perfluoropolyether being 90% or more by weight in the second lubricating layer.

13. The storage medium according to claim 8, further comprising:
a fixed layer provided below the second lubricating layer, for the second lubricating layer adhering to the fixed layer.

14. The storage medium according to claim 13, further comprising:
a layer having a second polar group below the fixed layer, the fixed layer including the first polar group.

15. The storage medium according to claim 8, wherein the second lubricating layer is outer than the first lubricating layer.

16. The storage medium according to claim 9, wherein the lubricant comprises a fluorinated material.

17. A method for manufacturing a storage medium comprising:
providing a substrate, and a storage medium layer for storing information on the substrate;
arranging a first lubricating layer on the storage medium layer;
removing an outer portion of the first lubricating layer; and
arranging a second lubricating layer on a area of the storage medium layer from which the first lubricating layer is removed, the first lubricating layer being outer than the second lubricating layer, the second lubricating layer having lower viscosity than the first lubricating layer.

18. The method according to claim 17, wherein removing the outer portion of the first lubricating layer is done by dipping a part of the outer portion to be removed, in a solvent in which the first lubricating layer is soluble while the substrate is rotated.

19. The method according to claim 17, wherein arranging the second lubricating layer on the area of the storage medium layer from which the first lubricating layer is removed is done by dipping only a part of the outer portion to be arranged, in a solution for forming the second lubricating layer while the substrate is rotated.

20. The method according to claim 17, wherein the solution for the second lubricating layer contains a perfluoropolyether having an end group —CH₂OH and being free of end group —CH₂OCH₂CH(OH)CH₂OH.
